(19) United States
(12) Patent Application Publication
(10) Pub. No.: US 2015/0164108 A1
(43) Pub. Date: Jun. 18, 2015

(54) METHODS OF PROCESSING WASTE ACTIVATED SLUDGE

(71) Applicant: Nutrinsic Corporation, Glendale, CO (US)

(72) Inventors: Andrew LOGAN, Denver, CO (US); Leo GINGRAS, Kinder, LA (US); Seth TERRY, Englewood, CO (US)

(21) Appl. No.: 14/475,455

(22) Filed: Sep. 2, 2014

Related U.S. Application Data
(60) Provisional application No. 61/916,365, filed on Dec. 16, 2013.

(51) Int. Cl. A23J 1/00; C02F 11/02

(52) U.S. Cl. CPC A23J 1/001; C02F 11/02; C02F 2203/00

(57) ABSTRACT

Methods for processing waste activated sludge obtainable from wastewater plants. The methods herein are useful in that they provide novel waste activated sludge preparations that are substantially free of live microbial organisms and contain a high content of digestible protein.

### CROSS-REFERENCE TO RELATED APPLICATIONS

This application claims priority to U.S. Provisional Application No. 61/916,365 titled “METHODS OF PROCESSING WASTE ACTIVATED SLUDGE”, filed Dec. 16, 2013, the disclosure of which is incorporated by reference herein in its entirety for all purposes.

### FIELD OF THE INVENTION

In various embodiments, the disclosure provided herein relates inter alia to novel methods for processing waste activated sludge obtainable or obtained from aqueous waste streams, products prepared therefrom such as solid protein feed products, and methods of preparing such products. These methods are useful in that they enhance water remediation and provide for a raw material that may be used for the production of various products, including for example an animal feed, a human food product, and/or a fertilizer.

### BACKGROUND

The manufacture of many industrially made products involves the use of water, resulting in the generation of an aqueous waste stream as a by-product of the manufacturing process. Prior to disposal of an aqueous waste stream, environmental regulations frequently stipulate that organic pollutants be removed from the waste stream. Strategies to remove pollutants include aerobic biological water treatment, e.g., by cultivating microbial organisms to convert the pollutants present in the aqueous waste stream and produce carbon dioxide, water and microbial cell mass.

A typical aerobic biological wastewater treatment process involves the cultivation of microbial cells within an aeration reactor comprising the aqueous waste and microbial cells grown in suspension in the aqueous waste. Often, wastewater is delivered continuously to the aeration reactor(s). The cellular suspension (known in the art as the “mixed liquor”) overflows into a solid-liquid separator (e.g. a clarifier or membrane based system), generating a clear effluent and microbial mass. This microbial mass may be returned to the aerobic reactor(s) (known as return activated sludge, or “RAS”) or it may be removed from the system and wasted; this solid waste is also known to the art as “waste activated sludge” or “WAS”. The effluent is discharged in a local waterway, injected underground or discharged in any other appropriate manner, and the microbial mass is commonly in part returned to the aeration reactor, and in part disposed as solid waste.

The wastewater treatment processes of the prior art exhibit significant drawbacks. The waste activated sludge component must be disposed of, and disposal costs reflect a significant cost component in the operation of a wastewater plant. Thus, in most instances, waste treatment plants are constructed and operated in such a manner that minimal costs are incurred in processing wastewater, with the goal of reaching a point that the wastewater and/or the waste activated sludge meets the minimal applicable requirements for disposal. It is a conventional objective of wastewater treatment operations to minimize the production of waste solids. Most commonly, this is achieved by holding the microbial cells within the system for an extended period where they will die, lyse, and be converted into carbon dioxide via microbial pathways and oxidation.

It is known in the art that waste activated sludge may be used as a raw material in the manufacture of valuable products, e.g. animal feed products (see: U.S. Pat. No. 7,931,806, hereafter, “the '806 patent”). In another process, the waste activated sludge is subsequently dewatered and dried after being removed from the wastewater treatment process to produce a fertilizer (a representative example of this is Milorganite® fertilizer that is manufactured and sold by the Milwaukee, Wis. sewerage district). Most commonly, this conversion to a fertilizer product is achieved by drying the waste activated sludge that was held within the wastewater treatment system for an extended period where microbial cells will die, lyse, and be converted into carbon dioxide via microbial pathways and oxidation 1) at high temperatures (often as high as 300 degrees Celsius) or 2) by exposing it to a high dose of microwaves. As a result, potentially beneficial constituents of the microbial cells such as protein, vitamins, and coenzymes are damaged and/or destroyed by the cellular production method, heat, or excessively high amounts of radiation. These processes significantly improve wastewater treatment economics. However, process steps are ordinarily not conducted in typical wastewater treatment facilities designed to process wastewater strictly to disposal standards.

The operation of wastewater facilities intended strictly for disposal purposes does not involve the performance of the above steps (i.e. for producing animal feed products or fertilizer) and will. Indeed, the above noted '806 patent involves dewatering the waste activated sludge, followed by drying through heat treatment using temperatures between 55° C. and 105° C. for less than a day. The processes provided in the '806 patent employ higher temperatures within the prescribed temperature range, i.e. at about 105° C., such that reductions in live bacterial cell content and reductions in water content are achieved; however, the exposure of substantially dewatered waste activated sludge to the higher temperatures within this range, e.g. at about 105° C., in accordance with the methods described in the '806 patent, can result in a substantial reduction of protein digestibility in the waste activated sludge, which in turn can affect the quality of the dried product. In particular, protein digestibility can be affected and this can limit the utility of the dried waste activated sludge as a raw material for the production of high quality animal feed products. On the other hand, at the lower temperatures within the prescribed temperature range provided in the '806 patent, e.g., at about 55° C., the protein structure may be less compromised; however drying will require a much longer period of time, and, importantly, can result in dried product which will contain a substantial viable bacterial load. The latter provides a dried waste activated sludge product which will be difficult to preserve and/or may not meet the safety standards required for the raw materials used for, for example, the manufacture of feed products. Additionally, the equipment required to dry large quantities of waste activated sludge at about 55° C. can be very large and/or prohibitively costly.

The processes of the present invention provide products with improved properties, for example improved microbial protein quality, lower live bacterial load, improved storage stability, and/or improved process economics compared to known methodologies for the production of microbial mass in wastewater treatment operations. In particular, the processes of the present invention provide products with reduced live bacterial load in the waste activated sludge, while at the same time providing for a material that comprises high quality protein.

### SUMMARY OF THE INVENTION

In some embodiments provided in the present disclosure, a method of producing a solid protein feed product from waste water is described that includes (a) growing microbial cells in an aqueous waste stream to produce waste activated sludge, and (b) dewatering the waste activated sludge to a solids content of about 9-28 wt. % solids. The disclosure further includes (c) drying the dewatered waste activated sludge to a solids content of about 80-90 wt. % solids, and (d) sterilizing the waste activated sludge before, during, or after said dewatering or drying to provide a solid protein feed product which is commercially sterile, whereby protein quality of the solid protein feed product is substantially unchanged from that of the waste activated sludge prior to sterilization and drying. In some embodiments, a solid protein feed product is prepared by the described herein. In some embodiments, the solid protein feed product is classifiable as a feed as defined in the “CODE OF PRACTICE ON GOOD ANIMAL FEEDING” of the Food and Agriculture Organization of the United Nations.

### BRIEF DESCRIPTION OF THE DRAWINGS

For a better understanding of the various example embodiments described herein, and to show more clearly how these various embodiments may be carried into effect, reference will be made, by way of example, to the accompanying figures. It should be understood that the figures herein are provided for illustration purposes and are not intended to limit the present disclosure.

FIG. 1. depicts a flow diagram of certain embodiments of the methods provided in the present disclosure.

FIG. 2 depicts a schematic of a reactor used for processing waste activated sludge.

FIG. 3 depicts a schematic of a reactor used for processing waste activated sludge involving the inactivation of microbial cells by electronic beam radiation.

FIG. 4 depicts a schematic of a reactor used for processing waste activated sludge involving the inactivation of microbial cells by microwave radiation.

### DETAILED DESCRIPTION OF THE INVENTION

Various processes or compositions will be described below to provide an example of an embodiment of each claimed subject matter. No embodiment described below limits any claimed subject matter and any claimed subject matter may cover processes, methods, compositions or systems that differ from those described below. The claimed subject matter is not limited to compositions or processes having all of the features of any one composition, method, system or process described below or to features common to multiple or all of the compositions, systems or processes described below. It is possible that a composition, device, system and/or process described below is not an embodiment of any claimed subject matter. Any subject matter disclosed in a composition, device, system or process described below that is not claimed in this document may be the subject matter of another protective instrument, for example, a continuing patent application, and the applicants, inventors or owners do not intend to abandon, disclaim or dedicate to the public any such subject matter by its disclosure in this document.

All publications, patents and patent applications are herein incorporated by reference in their entirety.

In its various embodiments, in the process of the present invention, microbial cells are removed from the system as early as possible in order to prevent death and lysis, and to maximize the production of microbial cells. This is in contrast to conventional wastewater treatment facilities designed to process wastewater strictly to disposal standards, where the microbial cells are removed from the system as late as possible (i.e., the cells are aged for as long as possible), or not at all, in order to convert as much of the microbial cell biomass to carbon dioxide as possible. This is because the objective of conventional wastewater treatment facilities is to minimize the production of waste products is much as possible. Furthermore, in order to render waste activated sludge useful for the manufacture of products as in the present invention, it is important to reduce its water content and the live bacterial load present therein.

In some embodiments, the present disclosure relates to methods of processing waste activated sludge, and to methods generally involving deactivation of the microbial cells present in the waste activated sludge while maintaining valuable cellular constituents, which may be accomplished by thermal, mechanical, radiation, or enzymatic treatment of waste activated sludge. The performance of methods of thermal treatment, in accordance herewith involves heating the microbial cells. The use of mechanical methods of deactivating the microbial cells, in accordance herewith involves exposure of the microbial cells to a rapid pressure drop or to ultrasonic cavitation. The use of radiation methods, in accordance herewith involves the use of gamma, electron beam, microwave, or other forms of radiation. The use of enzymatic methods involves the use of proteases and other enzymes that break down functional parts of the cell membrane (or cell walls in the cases of fungi) and result in cell lysis and disruption.

As described herein, there is provided at least one embodiment of a method that is beneficial in that it provides a dried waste activated sludge product substantially free of live microbial cells and, surprisingly, comprising large quantities of digestible protein. To the best of the inventors' knowledge, a dried waste activated sludge product substantially free of live bacteria and, in addition, rich in digestible protein has heretofore not been prepared. Surprisingly, a protein digestibility of 90% or more may be achieved in accordance with the methods disclosed herein. The methods provided are further advantageous in that they provide a raw material that has a commercially acceptable shelf-life and may be used for the formulation of a nutritious animal feed product, a human food product or a fertilizer product. Accordingly, in one aspect, the present disclosure provides in one embodiment a method of processing waste activated sludge comprising microbial cells obtainable or obtained from an aqueous waste stream, comprising the steps of:
(a) deactivating the microbial cells to obtain a waste activated sludge substantially free of live microbial cells; and
(b) dewatering the waste activated sludge to reduce the water content of the waste activated sludge to less than about 91% to obtain dewatered waste activated sludge.
   Alternatively, the process of the present invention (instead of steps “a” and “b”), comprises the steps of:
(c) removing water from the waste activated sludge to obtain (I) thickened waste activated sludge having a water content of from about 91% to about 96%; or (II) dewatered waste activated sludge having a water content of 80% or less; and
(d) deactivating the microbial cells to obtain a waste activated sludge substantially free of live microbial cells.

In certain embodiments, deactivating the microbial cells in steps (a) and (d) comprises thermally treating the waste activated sludge at a temperature of from about 121° C. to about 155° C. to obtain thermally treated waste activated sludge.

In certain embodiments, following step (c) and prior to step (d), the dewatered waste activated sludge or thickened waste activated sludge is dried to obtain dried waste activated sludge. Thus the present disclosure further includes in one aspect a method of processing waste activated sludge comprising microbial cells obtainable or obtained from an aqueous waste stream, comprising the steps of:
(a) deactivating the microbial cells to obtain a waste activated sludge substantially free of live microbial cells; and
(b) dewatering the waste activated sludge to reduce the water content of the waste activated sludge to less than about 91% to obtain dewatered waste activated sludge; or comprising the steps of
(c) removing water from the waste activated sludge to obtain (I) thickened waste activated sludge having a water content of from about 91% to about 96%; or (II) dewatered waste activated sludge having a water content of 80% or less; or
(d) drying the dewatered waste activated sludge or the thickened waste activated sludge to obtain dried waste activated sludge; and
(e) deactivating the microbial cells to obtain a dried waste activated sludge substantially free of live microbial cells.

In some embodiments, aspects of the disclosure are directed to methods of producing a solid protein feed product from waste water that include (a) growing microbial cells in an aqueous waste stream to produce waste activated sludge. The waste activated sludge can be characterized as having solid content as well as water/liquid content.

The method can further include (b) dewatering the waste activated sludge to a solids content of about 9-28 wt. % solids; (c) drying the dewatered waste activated sludge to a solids content of about 80-90 wt. % solids; and (d) sterilizing the waste activated sludge before, during, or after said dewatering or drying to provide a solid protein feed product which is commercially sterile, whereby protein quality of the solid protein feed product is substantially unchanged from that of the waste activated sludge prior to sterilization and drying.

In some embodiments, dewatering and drying steps, as described herein, may be carried out as separate unit operations, or alternatively, may be carried out simultaneously in the same operation. For example, the waste activated sludge can first be dewatered, e.g. to a solids content of about 9-28 wt. % solids in a first operation, then dried to a solids content of about 80-90 wt. % solids. Alternatively, the waste activated sludge may be subjected to a single unit operation in which the water in the waste activated sludge is continuously removed by mechanical and thermal means e.g. to a final solids content of about 90-28 wt. % solids. In such “continuous” processes, the solids content of the waste activated sludge is increased, e.g., to a solids content of inter alia about 9-28 wt. % during the operation, but is not isolated as such; rather the operation continues to remove water until it reaches the desired final solids content of about 90-28 wt. % solids.

Protein quality, as described herein, can be estimated based on any suitable measure of digestibility of the solid protein feed product. In some embodiments, an assay is used to determine protein digestibility, such as, for example, the Immobilized Digestive Enzyme Assay (IDEA®) by Novus®. In some embodiments, a scoring system, such as the Protein Digestibility Corrected Amino Acid Score (PDCAAS) adopted by the US Food and Drug Administration (FDA), can be employed. The protein quality after a particular process step or steps can be deemed to be substantially unchanged if the value, score, and/or any measure remains about the same as before that processing step or steps. For example, when using the IDEA® assay, triplicate analyses of a waste activated sludge sample dried in a ring drier with an inlet temperature of 235° C. and an outlet temperature of 88° C. may result in an individual amino acid's digestibility being calculated at 92%, 94%, and 96% versus a waste activated sludge sample dried in a tray dryer at 105° C. for 12 hours with the same amino acid's digestibility being calculated at 72%, 74%, and 76%. Statistical analysis using a paired T-test with a confidence interval of 95%, shows that there is a difference in the digestibility and; therefore, in the protein quality, of these samples.

In some embodiments, the total crude protein content of the solids content of the solid protein feed product is at least about 40 wt. %, as measured, for example, using Dumas or Kjeldahl methods (Wiles, P. G., I. K. Gray, and R. C. Kissling 1998. Routine Analysis of Proteins by Kjeldahl and Dumas Methods: Review and Interiaboratory Study Using Dairy Products, J. AOAC Int. 81:620-632).

In some embodiments, the total protein content of the solids content of the solid protein feed product is about 60-65 wt. %. In some embodiments, the total protein content of the solids content of the solid protein feed product is at least about 80 wt. %

In some embodiments, said sterilizing of step (d) is by e-beam, gamma irradiation, microwave radiation, enzymatic treatment, heating, ultrasound, pressure drop, or combinations thereof. In some embodiments, after said sterilizing at step (d), no single viable microbial species is present in amounts in excess of about 50 cfu/g. In some embodiments, after said sterilizing at step (d), no single microbial species is present in amounts in excess of about 10 cfu/g. In some embodiments, said sterilizing of step (d) is by heating at a temperature of from about 120° C. to about 160° C. In some embodiments, the residence time (calculated merely by measuring the time that the solid protein feed product is exposed to inactivation conditions) during said sterilizing of step (d) is less than about 20 minutes.

In some embodiments, said sterilizing of step (d) is by e-beam irradiation. In some embodiments, said sterilizing of step (d) is by gamma radiation.

In some embodiments, said sterilizing of step (d) is by microwave radiation. In some embodiments, a wavelength of the microwave radiation ranges from about 915 MHz to about 2450 MHz, and a microwave power of the microwave radiation ranges from about 8 kW to about 80 kW. In some embodiments, said sterilizing of step (d) occurs after said drying of step (c).

In some embodiments, said sterilizing of step (d) includes enzymatic treatment with proteases and/or other enzymes, whereby the functional parts of the cell membrane or cell wall are broken down. In some embodiments, said sterilizing of step (d) comprises exposing the waste activated sludge to a rapid pressure drop. In some embodiments, said sterilizing of step (d) comprises exposing the waste activated sludge to ultrasonic cavitation.

In some embodiments, said drying of step (c) is performed at a temperature from about 80° C. to about 315° C. In some embodiments, the residence time of the dewatered waste activated sludge during said drying of step (c) is from about 2 minutes to about 20 minutes.

In some embodiments, said drying of step (c) is carried out in a single pass oven, a dual pass oven, a rotary drum dryer, a ring dryer, a flash dryer, a spray dryer, a spin flash dryer, or a super-heated steam dryer. In some embodiments, said drying of step (c) is carried out in a rotary drum dryer or in a ring dryer.

In some embodiments, the method further includes step (e) adding a coagulant to the waste activated sludge. In some embodiments, the coagulant is added prior to said sterilizing of step (d). In other embodiments, the coagulant is added after said sterilizing of step (d). In some embodiments, the coagulant is selected from the group consisting of an anionic polymer, a non-ionic polymer, a cationic polymer, a polyacrylamide-based polymer, a human food-grade polymer, and an animal feed grade polymer, and combinations thereof.

In some embodiments, the method further includes step (f) adding a preservative to the waste activated sludge. In some embodiments, the preservative is selected from the group consisting of acids, bases, humectants, bactericidal agents, fungicidal agents, and any combination thereof.

In some embodiments, the water content of the solid protein feed product is 10% or less, and digestible protein content of the solids content is at least about 40 wt. %. In some embodiments, the digestible protein content of the solids content is at least about 50 wt. %. In some embodiments, the digestible protein content of the solids content is at least about 60 wt. %. In some embodiments, the digestible protein content of the solids content is at least about 70 wt. %. In some embodiments, the digestible protein content of the solids content is at least about 80 wt. %. In some embodiments, the digestible protein content of the solids content is at least about 90 wt. %.

In some embodiments, the protein feed product meets one or more regulatory standards. In some embodiments, the protein feed product is classifiable as a feed as defined in the “CODE OF PRACTICE ON GOOD ANIMAL FEEDING” (“Code”) of the Food and Agriculture Organization of the United Nations (accessible online at http://www.fao.org/docrep/012/i1379e/i1379e06.pdf as of the date of filing of this application). The “Code” defines a feed as any single or multiple materials, whether processed, semi-processed or raw, which is intended to be fed directly to food producing animals.

Aspects of the disclosure are further directed to a solid protein feed product prepared by the methods described herein. In some embodiments, the water content of the solid protein feed product is 10% or less and the digestible protein content of the solids content is at least about 40 wt. %. In some embodiments, the digestible protein content of the solids content is at least 50 wt. %. In some embodiments, the digestible protein content of the solids content is at least 60 wt. %. In some embodiments, the digestible protein content of the solids content is at least 70 wt. %. In some embodiments, the digestible protein content of the solids content is at least 80 wt. %. In some embodiments, the digestible protein content of the solids content is at least 90 wt. %. In some embodiments, the solid protein feed product is classifiable as a feed as defined in the “CODE OF PRACTICE ON GOOD ANIMAL FEEDING” of the Food and Agriculture Organization of the United Nations.

Terms of degree such as “substantially,” “about” and “approximately” as used herein refer to a reasonable amount of deviation of the modified term consistent with the conventional meaning of such terms, and the context of their usage. For example, when associated with a numerical value, “about” could refer to a deviation of e.g., ±10% (or ±5%, ±2%, ±1%, etc.) of the numerical value.

The wording “and/or” as used herein is intended to represent an inclusive-or. That is, “X and/or Y” is intended to mean X or Y or both, for example. As a further example, “X, Y, and/or Z” is intended to mean X or Y or Z or any combination thereof.

The term “aqueous waste stream,” “wastewater stream,” and variants thereof, as used herein refers to any wastewater effluent including, but not limited to, any effluent from industrial manufacturing processes, municipal, commercial and domestic sources, and runoff water from rainfall or flooding. The wastewater streams used in accordance with the present disclosure include, but are not limited to, wastewater streams obtained from food manufacturing processes, including wastewater streams comprising food by-products and residuals which require the removal of such food by-products and residuals prior to release into the open environment, and further include, but are not limited to, wastewater streams relating to one or more of beverage production processes, including beer breweries, distilleries, fruit juice production facilities and the like, potato processors, citrate manufacturers, yeast producers, palm oil mills, wet corn and rice millers, sugar manufacturers, meat rendering processes and other food production processes that release food-grade biological oxygen demand into effluent water. “Biological oxygen demand” or “BOD” as used herein refers to the quantity of oxygen required to degrade contaminants biologically in wastewater. In general, the BOD correlates with the quantity of biologically assimilable organic material present in wastewater. In preferred embodiments, the aqueous waste stream comprises a BOD of at least about 200 mg per liter of food by-product and residual contaminants.

The terms “waste activated sludge” or “WAS,” which may interchangeably be used herein, refers to microbial biomass grown using aqueous wastewater as a microbial growth medium. Growth techniques and methodologies for generating WAS typically involve the general steps of (i) microbial proliferation in a growth vessel or reactor, such as an aeration reactor, which is assembled to permit the use of an aqueous waste stream as a growth medium, (ii) separation of the microbial biomass from the aqueous effluent, using for example one or more settling tanks, clarifiers, membrane-based separation techniques or other processes and unit operations generally known to the skilled artisan, and (iii) removing a portion of the microbial biomass known as the “waste activated sludge.” Microbial proliferation is typically achieved by contacting the wastewater stream with microbial organisms, which may be endogenously present in the wastewater stream or exogenously supplied, preferably in one or more basins, in which oxygen is introduced to maintain aerobic metabolic conditions, for example by agitation and mixing. As noted earlier, WAS can be characterized as having solid content and water/liquid content.

Furthermore, the wastewater stream may be supplemented with nutrients, e.g. micronutrients and/or macronutrients, in order to stimulate microbial growth. The microbial organisms metabolize the waterborne contaminant residuals contained in the aqueous wastewater and convert these residuals to microbial biomass, in the process consuming energy (in the form of carbon contained in the wastewater stream). In order to separate the microbial organisms from the treated wastewater, the contents of the wastewater basins are typically allowed to settle in a clarifier basin. Alternatively growth and separation are carried out in the same vessel, e.g. by periodically altering the operating conditions (e.g. terminating agitation in the vessel thereby permitting settling of the microbial mass). Other systems for separation may also be used, for example, membrane based bioreactors, involving the use of filters to separate the microbial organisms, or dissolved air floatation, may also be used. A portion of the microbial organisms is then typically returned to the aeration basin(s) to maintain a high concentration of microbial organisms therein, while the remaining portion is collected as waste activated sludge in accordance herewith. The collected waste activated sludge typically comprises from about 1% to about 2% solids and from about 98% to about 99% water.

In some embodiments, the microbial proliferation process is carried out under essentially aerobic conditions. The term “essentially aerobic conditions” is intended to refer to conditions where the growth of the microbial organisms under conditions where oxygen supply is controlled by aeration in such a manner that predominant growth of microbial species digesting carbon in an aerobic manner is promoted. While some anaerobic growth may occur, such growth is preferably limited to less than 50%, more preferably to less than 25%, and most preferably to less than 10%. Typically in order to achieve essentially aerobic growth conditions a supply of oxygen to the aqueous waste stream in an amount of at least 0.5 ppm, more preferably at least 1-2 ppm is required. The microbial organisms produced under essentially aerobic conditions are also referred to as “aerobic microbial organisms.” Two operating parameters that are of particular import in microbial proliferation are the “mean cell residence time” or “MCRT” and the “mean waste residence time” or “MWRT.” The MCRT can be calculated by dividing the total mass of microbial organisms in the wastewater treatment process by the mass of the microbial organisms removed (or wasted) per unit time. The total mass of microbial organisms in the process can be measured by various conventional methods, for example by removing samples of known volume from the aerobic basins and clarifiers, filtering the microorganisms out of the wastewater sample using a membrane filter with a nominal pore size of approximately one micron, drying the filter and captured cells, calculating the mass of microbial organisms in the samples, and extrapolating the mass of the microbial organisms in the samples to the mass of the microbial organisms in the total volume present in the process. “Residence time” of other systems (for example, within a drier in which material is constantly added and removed, can be calculated by dividing the total mass in the system at any instant by the rate at which mass is removed.

By way of example, if the total mass of microbial organisms is 100 pounds, and 20 pounds of microbial organism mass is removed per day, the MCRT is 5 days. In preferred implementations, the MCRT is about 8 days or less. In other embodiments, the MCRT is maintained to be about 7 days, about 6 days, about 5 days, about 4 days, about 3 days or about 2 days. Said another way, in preferred embodiments, no more than ⅛, 1/7, ⅙, ⅕, ¼, ⅓, ½ per day of the microbial organism mass, by weight or volume, is removed from the microbial proliferation process. The MWRT refers to the mean residence time of the carbon containing compounds in the process (e.g. the organic compounds contributing to the BOD of the waste stream), and can be measured from the time at which these compounds enter the process (e.g. enter the aeration vessel), and ending at the time at which these compounds are recovered from the process in the form of preserved, inactivated and/or dried microbial biomass. The MWRT can be calculated by dividing the total mass of carbon in the process by the total mass of carbon that is recovered per day. By way of example, if the total mass of carbon in the process is 100 pounds and 15 pounds of carbon is recovered per day, the MWRT is 6.7 days. In preferred embodiments, the MRWT is about 10 days or less. In further preferred embodiments, the MWRT is less than about 8 days, less than about 7 days, less than about 6 days, less than about 5 days, less than about 4 days, less than about 3 days or less than about 2 days. Further operating parameters for the production of microbial organisms and waste activated sludge will be generally known to those of skill in the art and can be readily determined and optimized through routine experimentation by those of skill in the art. Further guidance on control and optimization of MWRT and MCRT and other operating parameters relating to the growth and recovery of the microbial biomass in accordance herewith additionally may be found in the '806 patent the disclosure of which is incorporated herein by reference in its entirety.

The term “dewatering” as used herein refers to any processing step(s) that results in the removal of water from waste activated sludge. In some embodiments, such removal of water via dewatering results in a dewatered waste activated sludge having a water content from about 72% to about 91%, including all values in between.

The term “thickening” as used herein refers to any processing step(s) that results in the removal of water from waste activated sludge. In some embodiments, the thickened waste activated sludge has a water content of from about 91% to about 96%, including all values in between.

The term “drying” as used herein refers to any processing step(s) that is conducted using a dewatered or thickened waste activated sludge composition and results in the removal of water from such dewatered or thickened waste activated sludge to obtain a dried waste activated sludge product. In some embodiments, the dried waste activated sludge product has a water content of from about 4% to about 20%, including all values in between.

The term “lysis” as used herein refers to any processing step(s) that result in the substantial disruption of the cellular membrane of microbial cells.

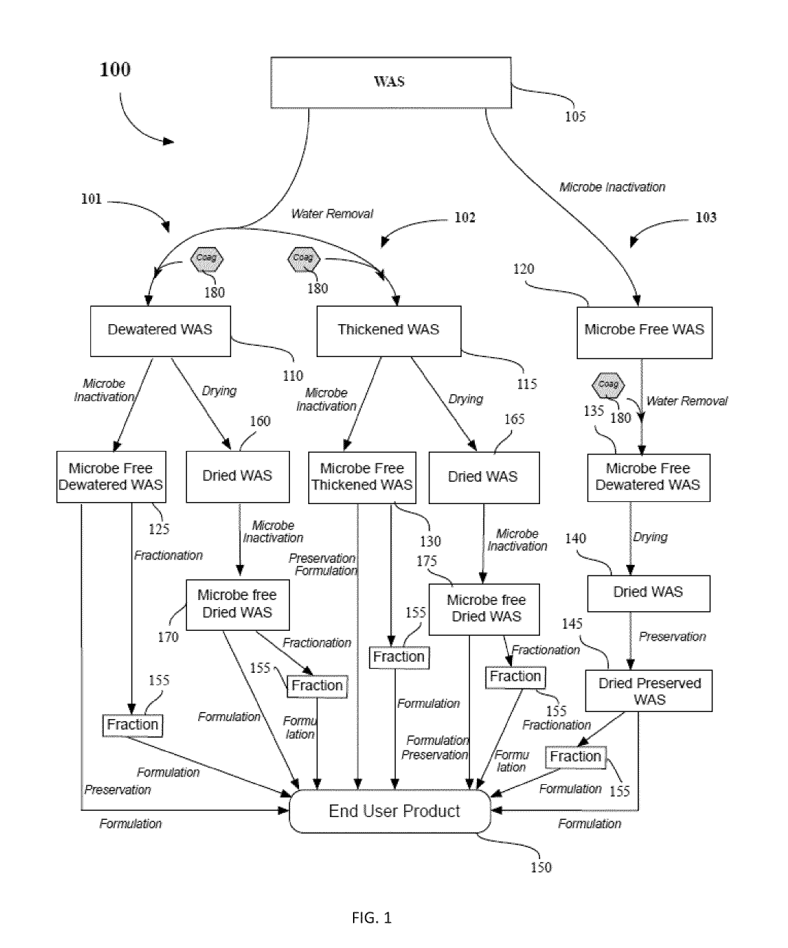

In some embodiments the present disclosure provides methods for processing waste activated sludge obtainable from or obtained from an aqueous waste stream, such as illustrated in FIG. 1. Referring to schedule 100 in FIG. 1, in one aspect, the present disclosure provides in 101, 102, and 103, three methods for processing waste activated sludge 105 obtainable or obtained from an aqueous waste stream. In methods 101 and 102, in an initial step, the waste activated sludge 105, is treated to remove water and to obtain either dewatered waste activated sludge 110 or thickened waste activated sludge 115, respectively. In both methods 101 and 102, the waste activated sludge (dewatered, 110 or thickened, 115) is subsequently microbially inactivated to obtain dewatered waste activated sludge that is free of viable microbes (dewatered, 125 or thickened 130). The microbial inactivation step may also be conducted following an optional drying step to initially obtain dried waste activated sludge 160 and 165, and thereafter microbe free dried waste activated sludge, 170 and 175. In the third method 103, waste activated sludge 105 is treated to remove microbial cells and to obtain microbe free waste activated sludge 120. Following inactivation of microbial cells, the waste activated sludge is dewatered to obtain microbe free dewatered waste activated sludge 135. Thereafter, in accordance with method 103, the microbe free dewatered waste activated sludge 135, is dried to obtain dried microbe free waste activated sludge 140 and preserved to obtain dried preserved waste activated sludge 145. Each of the waste activated sludge products 125, 170, 130, 165, and 145 may subsequently be directly formulated to prepare an end user product 150, or they may be used to prepare various fractions 155, as hereinafter described, which in turn may be used to prepare various end user products 150. In some embodiments, a coagulant 180, may be used at various steps in the processes of embodiments 101, 102 and 103, as illustrated in FIG. 1.

In accordance with certain aspects hereof, any suitable means of deactivating the microbial cells present in the waste activated sludge can be applied in order to obtain a waste activated sludge substantially free of live microbial cells (referring to FIG. 1, reference characters 125, 170, 130, 175 and 135). In accordance herewith, in certain embodiments (referring to FIG. 1, method 103), the method of deactivation is applied immediately following the separation of the waste activated sludge from the treated wastewater or wastewater treatment process, i.e. the method of deactivation is applied to waste activated sludge prior to dewatering, thickening or drying the waste activated sludge, or any other processing step resulting in substantial water removal from the waste activated sludge. Initially, the waste activated sludge 105 can include from about 97% to about 99.5% water. In such embodiments, the method of deactivation preferably comprises thermal treatment of the cells. In other embodiments (referring to FIG. 1, methods 101 and 102), however, the method of microbial deactivation is applied either (i) following dewatering of the waste activated sludge 105 to obtain a dewatered waste activated sludge 110 having a water content of 80% or less or (ii) following a thickening of the waste activated sludge to obtain a thickened waste activated sludge 115 having a water content of 91% to 96%. Thus the initial waste activated sludge 105, in accordance with this embodiment may have from about 97.5% to about 99.5% water. Its water content is then reduced to about 91%, about 92%, about 93%, about 94%, about 95% or about 96%, or any value in between, to obtain the thickened waste activated sludge 115, or its water content is reduced to for example about 80%, about 78%, about 76%, about 74%, about 72%, about 70%, or any value in between, to obtain the dewatered waste activated sludge 110. Thereafter the method of deactivation of microbial cells is applied. In some embodiments, the method of deactivation can include, but is not limited to, thermal treatment, treatment with ionizing radiation, cell lysis, and combinations thereof.

Thus it will be clear from the foregoing that the water content of the waste activated sludge used in conjunction with the method of deactivating the microbial cells present in the waste activated sludge in accordance with various embodiments may range (i) from about 97% to about 99.5% (referring to FIG. 1, method 103); (ii) from about 91% to about 96% (referring to FIG. 1, method 102); and (iii) 80% or less (referring to FIG. 1, method 101). Various methods of deactivating microbial cells may be applied, provided however, that the methods of deactivating microbial cells result in a waste activated sludge substantially free of live microbial cells. The term “substantially free of live microbial cells” means that, following application of the method of deactivating the microbial cells, no single microbial species in the waste activated sludge is present in amounts in excess of about 100 colony forming units per dry gram (“cfu/g”) of waste activated sludge. The term “substantially free of live microbial cells” can further encompass application of methods of deactivation of microbial cells, wherein following application, no detectable levels (i.e. about 0 cfu/g) of live bacterial cells are present in the waste activated sludge.

In certain embodiments, upon deactivating the microbial cells present in the waste activated sludge, no single microbial species is present in the waste activated sludge in amounts in excess of about 50 cfu/g, or in excess of about 10 cfu/g, and all values in between. In some embodiments, the microbial count in the waste activated sludge is about 0 cfu/g. Although in accordance herewith, no microbial species in the waste activated sludge is present in amounts in excess of about 100 cfu/g. In certain embodiments, a first microbial species is present in a concentration of about 100 cfu/g and a second microbial species is present in an amount less than about 100 cfu/g. The foregoing very low levels of microbial count can be further termed as “commercially sterile.” For example, if the final product is used for the manufacture of feed applications, Salmonella species are preferably present at about 0 cfu/g, and Escherichia coli species are present at levels up to about 100 cfu/g, or at levels of up to about 10 cfu/g. The product so defined in respect to its microbial counts can be deemed commercially sterile. Through variation of the methods of deactivation, variations in the very low levels of microbial counts may be obtained. In some embodiments, the product can be deemed commercially sterile when classifiable as a feed as defined in the “CODE OF PRACTICE ON GOOD ANIMAL FEEDING” of the Food and Agriculture Organization of the United Nations.

In embodiments where a method of thermal treatment is applied to deactivate microbial cells, longer heating times and/or the use of higher temperatures can result in a lower microbial count. In embodiments where a high pressure cell lysing means is applied, the use of higher pressure differentials can result in a lower microbial count. As another example, in embodiments where ultrasonic cavitation is used, extended duration of exposure to ultrasonic frequencies can result in a lower microbial count. As yet another example, in embodiments where ionizing radiation is used, longer exposure to radiation can result in a lower microbial count as will exposure to more intense frequencies or forms of radiation. As yet another example, in embodiments where enzymatic digestion is used, extended exposure time, or exposure to multiple enzymes can result in a lower microbial count. Thus, depending on the specific use of the final waste activated product, the specific conditions relating to the application of the deactivation means may be adjusted to achieve a range of microbial counts and a commercially sterile product may be obtained.

Microbial species that may be monitored comprise a wide variety of bacterial species including, but not limited to Escherichia coli, Clostridium perfringens, Staphylococcus aureus, Bacillus spp, and Campylobacter jejuni. Other microbial organisms that may be monitored include but are not limited to Salmonella spp., yeast and mold spp., Clostridium spp., including sulfite-reducing Clostridia, the family of Enterobacteriaceae, and bacterial species in the class of coliform bacteria. The extremely low levels of microbial organisms obtained in accordance herewith render the waste activated sludge commercially sterile and suitable for use as a raw material for the commercial manufacture of many products, including animal feed products, human food products and fertilizers.

In accordance with some embodiments of the methods of the present disclosure, waste activated sludge is thermally treated at a temperature of from about 121° C. to about 155° C. to obtain thermally treated waste activated sludge. The use of such thermal treatment results in the substantial inactivation of microbial organisms in the waste activated sludge and substantially non-viable waste activated sludge is obtained. In certain embodiments, the thermal treatment is applied immediately following the separation of the waste activated sludge from the treated wastewater, i.e. the thermal treatment is applied to waste activated sludge prior to dewatering or drying the waste activated sludge (i.e. the waste activated sludge has a water content of about 97% to about 99.5%) (referring to FIG. 1, method 103), or in other embodiments following any other processing step resulting in substantial water removal from the waste activated sludge (i.e. a thickening step resulting in waste activated sludge having a water content from about 91% to about 96% (referring to FIG. 1, method 102); or a dewatering step resulting in a waste activated sludge having a water content of about 80% or less (referring to FIG. 1, method 101). The thermal treatment of the waste activated sludge in accordance herewith is generally relatively short in duration. Thus, in certain embodiments the thermal treatment does not exceed about 20 minutes, and in other embodiments thermal treatment will vary from about 5 minutes to about 20 minutes, including all values in between. When employing higher temperatures within the prescribed temperature range, the thermal treatment time can be shorter in duration and when using the lower temperatures within the prescribed temperature range the treatment time can be longer. In some embodiments, thermal treatment will comprise heating the waste activated sludge for at least 20 minutes or about 20 minutes, e.g., for at least 20 minutes or about 20, at least 21 minutes or about 21 minutes, at least 22 minutes or about 22 minutes, at least 23 minutes or about 23 minutes, at least 24 minutes or about 24 minutes, at least 25 minutes or about 24 minutes, or at least 30 or about 30 minutes, and all values in between. In some embodiments, the thermal treatment can be conducted at a temperature of at least 121° C. or about 121° C., e.g., of at least 120° C. or about 120° C., of at least 119° C. or 119° C., of at least 118° C. or about 118° C., of at least 117° C. or about 117° C., of at least 116° C. or about 116° C., of at least 115° C. or about 115° C., of at least 110° C. or about 110° C., and all values in between. In another particular embodiment the thermal treatment will comprise heating the waste activated sludge for at least 5 minutes or about 5 minutes, e.g., at least 5 minutes or about 5 minutes, at least 6 minutes or about 6 minutes, at least 7 minutes or about 7 minutes, at least 8 minutes or about 8 minutes, at least 9 minutes or about 9 minutes, or at least 10 minutes or about 10 minutes, and all values in between; and at a temperature not exceeding 200° C. or about 200° C., not exceeding 180° C. or about 180° C., not exceeding 170° C. or about 170° C., not exceeding 160° C. or about 160° C., not exceeding 155° C. or about 155° C., not exceeding 154° C. or about 154° C., not exceeding 153° C. or about 153° C., not exceeding 152° C. or about 152 ° C., not exceeding 151° C. or about 151° C., not exceeding 150° C. or about 150° C., and all values in between. In yet another particular embodiment, thermal treatment will comprise heating the waste activated sludge for about 20 minutes at a temperature of 121° C., and in another embodiment the thermal treatment will comprise heating the waste activated sludge for about 5 minutes at a temperature of 155° C. Following thermal treatment the waste activated sludge is preferably rapidly cooled (e.g., within less than 5 minutes) to less than about 100° C., for example by passing the sterilized waste activated sludge through a heat exchanger or by transporting the waste activated sludge to tanks or other holding vessels that are typically open to atmospheric pressure. Thermal treatment methods and devices that may be used in accordance herewith include any methods and devices capable of heating substantially liquid materials to temperatures between from about 121° C. to about 155° C. while retaining the water content of these liquid materials between about 92% and about 99%. In certain embodiments, however, substantial water loss of the waste activated sludge and drying may occur as a result of the application of a thermal methods or lysing method, reducing the water content to e.g. 50%, 40% or 30%. Such devices include sterilization devices such as, but not limited to, tubular sterilization devices, plate heat exchanger sterilization devices, ultra-high temperature sterilization or pasteurization devices, autoclaves, and/or the like. In some embodiments, such devices can permit a continuous flow of waste activated sludge.

In accordance with some embodiments, the methods described herein include a method of lysing the microbial organisms present in the waste activated sludge to achieve microbe inactivation and obtain waste activated sludge comprising lysed microbial cells. In accordance with some embodiments, the method of lysing the microbial organisms is applied following dewatering or following dewatering and drying of the waste activated sludge to a water content of about 80% or less, for example about 70%, about 60%, about 50%, about 40%, about 30% or less, including all values in between, or any other processing step resulting in substantial water removal from the waste activated sludge. Methods of lysis that may be used in accordance herewith include, but are not limited to, pressure modulation, ultrasonic cavitation, enzymatic based lysis techniques, and combinations thereof. In some embodiments, a lysing methodology that may be used in accordance herewith is the “French pressure cell press”, or “French press”, or decompression rupturing, or similar terminology.

Briefly, French pressing of waste activated sludge involves pressing the waste activated sludge fluid in a vessel and under high pressure forcing the material through a narrow valve or orifice. In order to achieve the requisite pressure, a hydraulic pump may be used to drive a piston into a closed vessel, for example a cylinder. The piston is sealed with for example, an O-ring, so that the route of escape for the waste activated sludge from the vessel is through the valve. A typical pressure that is applied in accordance herewith is about 5,000 psi or more. Upon exiting through the valve the microbial cells are subjected to shear forces and a rapid decompression to ambient pressure. Under these conditions, the microbial cells present in the waste activated sludge rupture and lyse. When applied to solid-phase materials, this process is performed using a Hughes Press or X-press. French press, Hughes press, and X-press methodologies are further described in Harrison, S. T. L. (1991). Bacterial Cell Disruption: A Key Unit Operation in the Recovery of Intracellular Products. Biotech. Adv., 9, 217-240. Lower pressures can also achieve effective lysis when the cells are heated. For example, a pressure drop of 100 psi to 1000 psi results in significant lysis and deactivation when the WAS is preheated to approximately 121° C. Higher temperatures require lower pressure drop differentials. Thus, there exists any number of pressures to temperature scenarios that will result in lysis of the cells. For example, the present inventors have observed significant lysis through a pressure drop of about 30 psi when the WAS is heated to about 121° C.

Other methods that may be used to lyse or deactivate the cells include ultrasonic cavitation. Briefly, ultrasonic frequencies in the 18 kHz-1 MHz range produce cavitation phenomena where microbubbles expand and contract. Upon contact, a shock wave passes through the medium. The repetition of this bubble growth, contraction, and shock wave emission results in lysis and disruption of biological cells. Ultrasonic methodologies are further described in H. Feng, G. V. Barbosa-Cánvas, and J. Weiss (Eds.) (2011). Ultrasound Technologies for Food and Bioprocessing (2011). New York: Springer. Further methods that may be used to lyse or deactivate cells are enzymatic methods including, but not limited to, proteases, lipases, lysozymes, or other enzymes, and combinations thereof. Enzymatic methodologies are further described in: Aehle, W (ed.) (1990). Enzymes in Industry, Weinheim, Germany: Wiley VCH. Further methods that may be used to lyse or deactivate cells are chemical methods, including, but not limited to methods of treatment of the waste activated sludge with strong acids, or bases, or hygroscopic compounds. Acids that may be used in this regard include hydrochloric acid, nitric acid, and sulfuric acid, and other acids; bases that may be used include sodium hydroxide and calcium hydroxide, and other bases; hygroscopic compounds that may be used in this regard include humectants, including: propylene glycol, sorbitol, and glycerol.

In accordance with some embodiments, microbial inactivation is achieved by treatment of the waste activated sludge using ionizing radiation, including gamma radiation, electron beam (e-beam), or microwaves. In accordance herewith, the radiation is preferably applied following dewatering of the waste activated sludge, using a dewatered waste activated sludge having a water content of 80% or less or a dried waste activated sludge. In particular embodiments, a dried waste activated sludge having a water content of 10% is used. Radiation dosing may vary, but in embodiments where e-beam treatment is used, a range of 2 to 14 kilogray is preferred. Molins (2001) provides data showing that lower e-beam doses can also be effective. (Molins, R. A. (ed.) (2001). Food Irradiation: Principles and Applications. New York: Wiley Interscience.) Where microwaves are used, the dose applied is generally between 8 and 80 kW for a period of 1 to 15 minutes. The ‘inventors’ data has shown that 75kW for a period of 3-5 minutes achieves 3-log inactivation of total microbes with Salmonella and total coliform analyses being negative after irradiation. This dose does not result in a reduction in pepsin digestibility. Molins (2001) also provides data regarding gamma irradiation doses that are required to achieve commercial sterility that renders a product suitable for use as an animal feed ingredient. For example, a typical specification for microbial counts in an animal feed ingredient may be as listed in Table 1 below:

TABLE 1

| | VALUES | UNITS |
|---|---|---|
| Salmonella spp | NEGATIVE IN 25 g | |
| Escherichia coli | maximum 10 | MPN |
| Clostridium perfringens | maximum 100 | CFU/g |
| Yeast and molds | maximum 100 | MPN |
| Enterobacteriaceae | maximum 100 | CFU/g |
| Staphylococcus aureus | maximum 100 | CFU/g |
| Bacillus cereus | maximum 100 | CFU/g |
| sulphite-reducing Clostridia | maximum 100 | CFU/g |
| Campylobacter jejuni | maximum 100 | CFU/g |
| Total coliforms | maximum 10 | MPN |

Methods such as DNA sequencing, monoclonal antibody capture and enumeration, culturing, and others can be used to determine the initial concentration of these microorganisms in a sample before and after irradiation. The dose of radiation can therefore be increased or decreased to achieve the desired level in the final product. It is to be expected that levels of microbes in ingredients destined for human foods would be significantly lower than those shown above.

In accordance with certain embodiments (referring to FIG. 1, methods 101 and 103), the waste activated sludge is dewatered to obtain dewatered waste activated sludge, such dewatered waste activated sludge having a water content of no more than about 91%. In more preferred embodiments, the dewatered waste activated sludge has a water content of about 85% or less, and in particular embodiments the waste activated sludge has a water content of about 80%, or less. At a water content of about 80% the waste activated sludge is generally sufficiently liquid in order to be pumped to perform any additional processing steps conveniently and thus it is often preferred to maintain the water content no lower than about 80%. The dewatering methods that may be used in accordance herewith includes any dewatering device, including, but not limited to, any device capable of expelling water from waste activated sludge, through the use of mechanical force, such as, including but not limited to, any device operated by applying pressure or centrifugal force. Methodologies and equipment that may be used in accordance herewith to achieve dewatering include, but are not limited to, presses and centrifuges. Devices for dewatering that may be used include but are not limited to, for example a belt filtering press, a centrifuge, a vacuum assisted press, a filter press column, a screw press, a rotary press, a drum thickener, a gravity belt thickener, an electrically mediated dewatering unit, an extrusion dewatering unit or a plate and frame press.

In particular embodiments, a decanter centrifuge or a belt filter press are used to dewater the thermally treated waste activated sludge. In the operation of the dewatering step, the temperature of the waste activated sludge is generally not substantially modulated. It is noted however that the temperature in the course of dewatering may vary substantially in view of the fact that in certain embodiments thermally treated waste activated sludge may upon thermal treatment immediately be subjected to dewatering. In such embodiments, the temperature during dewatering will generally decline. In other embodiments, the thermally treated waste activated sludge or lysed waste activated sludge is subjected to dewatering at ambient temperature and in such embodiments the temperature during dewatering will generally remain within about 20° C. of the ambient temperature.

In accordance with certain embodiments (referring to FIG. 1, method 102), the methods of the present disclosure can include thickening of the waste activated sludge. Such thickening may be achieved using any device operated by means of applying pressure or centrifugal force. Methodologies and equipment used for thickening are most commonly settlers and rotary drum thickeners. Methodologies and equipment that may be used in accordance herewith to achieve dewatering include, but are not limited to, presses and centrifuges.

In accordance herewith, upon the performance of the deactivation of the microbial cells, and dewatering of the waste activated sludge, the waste activated sludge is substantially free of live microbial cells, and the waste activated sludge is rich in protein, notably the waste activated sludge comprises protein wherein at least about 50% of the protein present therein is digestible, more preferably at least about 60%, more preferably at least about 70%, more preferably at least about 80%, and most preferably at least about 90%, e.g., at least about 91%, at least about 92%, at least about 93%, at least about 94%, at least about 95%, at least about 96%, at least about 97%, and all values in between. The foregoing may be determined by measuring the total protein and/or amino acids delivered to an animal in its feed, and comparing it with the total protein and/or amino acids excreted in the animal's feces. Thus, for example, a waste activated sludge comprising 90% digestible protein, would, when prepared as an animal feed, result in 10% of the total protein delivered being present in the feces of the animal. In vivo digestibility may be quantitated using the methods provided in Skrede, A., et. al, 1998. Digestibility of bacterial protein grown on natural gas in mink, pigs, chicken, and Atlantic salmon. Anim. Feed. Sci. Technol. 76 (103-116). Boisen digestibility is described in S. Boisen and Fernandez, J. (1995). Prediction of the apparent digestibility of protein and amino acids in feedstuffs and feed mixtures for pigs by in vitro analyses. Animal Feed Science and Technology, 51, 29-43. Pepsin digestibility is described in Bassompierre, M., Larsen, K. L., Zimmermann, W., McLean, E., Borresen, T., Sandfeld, P. (1998). Comparison of chemical, electrophoretic and in vitro digestion methods for predicting fish meal nutritive quality are described in Aquaculture Nutr., 4, 223-239. The IDEA protein digestibility assay is described in: Boucher, S. E., S. Calsamiglia, C. M. Parsons, M. D. Stern, M. Ruiz Moreno, M. Vazquez-Anon and C. G. Schwab. 2009. In vitro digestibility of individual amino acids in rumen-undegraded protein: The modified three-step procedure and the immobilized digestive enzyme assay. J. Dairy Sci. 92:3939-3950. Digestibility assays and results thereof using the methodologies of the present disclosure are additionally further described in Examples 76, 78, 79 and 80.

In some embodiments of the present disclosure the methods of processing further include a drying step. Thus the present disclosure further includes in one aspect a method of processing waste activated sludge comprising microbial cells obtainable or obtained from an aqueous waste stream, comprising the steps of:
(a) deactivating the microbial cells to obtain a waste activated sludge substantially free of live microbial cells; and
(b) dewatering the waste activated sludge to reduce the water content of the waste activated sludge to less than about 91% to obtain dewatered waste activated sludge.
   Alternatively, the process of the present invention (instead of steps “a” and “b”), comprises the steps of:
(c) removing water from the waste activated sludge to obtain (I) dewatered waste activated sludge having a water content of 80% or less; or (II) thickened waste activated sludge having a water content of from about 91% to about 96%; and
(d) following step (b) or step (c) drying of the dewatered waste activated sludge or the thickened waste activated sludge.

In a particular embodiment, drying is performed at a temperature between about 80° C. and about 315° C. for a drying period no longer than about 10 minutes to obtain dried waste deactivated sludge.

In accordance herewith, in certain embodiments the dried waste activated sludge has a water content of 20% or less, a water content of 15% or less, and most preferably a water content of about 10% or less.

In some embodiments, the dewatered waste activated sludge is rapidly dried at a temperature between about 80° C. and about 315° C. for a drying period no longer than about 10 minutes, using drying equipment capable of delivering these operating parameters, such as including but not limited to a single pass oven, a dual pass oven, a rotary drum drier, a ring dryer, flash dryer, a spray dryer, spin flash dryer, or a super-heated steam dryer. Ringer dryers, swirl fluidizers, spin flash dryers, spray driers and super-heated steam dryers are often used as they are particularly compatible with the temperature sensitivity of the microbial proteins and, in some instances, can provide for a consistent particle size distribution.

Briefly, a spray dryer is a device comprising a spray nozzle through which a liquid comprising particulate matter, e.g. waste activated sludge, is transported and dispersed into droplets, which are contacted with a hot air or gas (heated nitrogen for example), preferably provided in a stream. Upon contact of the droplets with the hot air or gas, the liquids in the droplets evaporate and dried solids form. These solids are recovered, usually in the form of a powder, and in accordance herewith referred to as dried waste activated sludge. The moisture content of these solids is less than 10%. In accordance herewith a spray drier is advantageously operated so that the temperature at which the droplets are dispersed into the heated air or gas is controlled and in particular embodiments is about 300° C., and the outlet temperature about 80-100° C. Spray dryer methodologies are further described in Mujumdar, A. S. (ed.) (2007). Handbook of Industrial Drying, (Third Edition). Boca Raton: CRC Press and Land, C. M. Van't. (2012). Drying in the Process Industry, Hoboken: John Wiley and Sons.

Ring dryers also may conveniently be used and involve the use of centrifugal force created by an air or gas stream passing around a curve to concentrate dispersed waste active sludge dispersed in the ring dryer in a moving layer. Dry particles within the waste activated sludge are leaving the circulation of the system, while wetter particles recycle through the system. The ring dryer is preferably operated in such a manner that the inlet temperature is controlled to be within a range of from about 200° C. to about 315° C. and more preferably about 260° C. The outlet temperature is within the range of from about 82° C. to about 93° C. This provides for a product having a moisture content of about 10% and the consistency of a powder. The ring dryer is preferably operated in such a manner that multiple cycles are performed and in such a manner that about 97.5% of the waste exits the ring dryer within about 2-4 minutes. Ring drier methodologies are further described in Mujumdar, A. S. (ed.) (2007). Handbook of Industrial Drying, (Third Edition). Boca Raton: CRC Press and Land, C. M. Van't. (2012). Drying in the Process Industry, Hoboken: John Wiley and Sons.

Superheated steam driers may also be used to achieve drying and involve the use of air to pneumatically convey the waste activated sludge within a flow of superheated transport steam. The dryers often operate in a closed loop system that will allow for steam and energy recovery and recycling. The superheated steam may be produced by a variety of means including gas, oil, or electric boilers, heat exchangers or other steam generation equipment, flue gases or thermal oil. Also, electrical heating can be applied. The moisture that is evaporated from the product is used to form excess steam and lower the temperature of the superheated steam. The normal residence time of the waste activated sludge in a super-heated steam system is generally lower than one minute and can be as low as just a few seconds (2-5 seconds, for example). Superheated steam dryers, or steam loops can be applied in series in order to achieve specific levels of dryness. Transport steam and the dry product are most often separated in a cyclone- or bag-type separator with the preferred method most often being the cyclone-type separator and the dried product is then discharged from the dryer with the use of an air-tight rotary valve or similar apparatus. After separation, the transport steam is recycled to the inlet of the heat exchanger to be re-heated. Excess steam generated is continuously bled off. Superheated steam drying is further described in Mujumdar, A. S. (ed.) (2007). Handbook of Industrial Drying, (Third Edition). Boca Raton: CRC Press and Land, C. M. Van't. (2012). Drying in the Process Industry, Hoboken: John Wiley and Sons.

In another embodiment, drying of the waste activated sludge is achieved using microwave radiation. In general, microwave-based drying of the dewatered activated sludge is performed using a microwave dose and wavelength for a sufficiently long period of time to dry the dewatered activated sludge and obtain a dewatered activated sludge having a water content of less than about 90% water, more preferably less than about 80%, less than about 70%, less than about 60%, less than about 50%, less than about 40%, less than about 30%, less than about 20% or less than about 10% water, including all values in between. Preferable radiation ranges vary from about 800 MHz to about 2450 MHz, more preferably between about, 900 and 1,000 MHz, and most preferably about 915 MHz, including all values in between. Preferable operating power ranges vary from about 10kW to about 20 kW, including all values in between. The selected wavelength, power and the duration of exposure depends primarily on the initial and final desired moisture content of the dewatered waste activated sludge. Microwave equipment that may be used in accordance with the present disclosure is any microwave equipment, including any industrial microwave equipment such as equipment sold by Industrial Microwave Systems LLC or Burch Biowave Systems. For example, the inventors have determined that at a microwave frequency of about 915 MHz and an initial dewatered sludge moisture content of about 80%, drying to obtain a waste deactivated sludge having a moisture content of about 10% requires approximately 25 minutes at about 20 kW. If dewatered activated sludge is used having an initial moisture content of about 20%, 3 minutes and 15 seconds of exposure to about 915 MHz microwaves at about 10 kW reduces the water content of the dewatered waste activated sludge to slightly less than about 10%.

In particularly preferred embodiments of the present disclosure, the dewatered waste activated sludge is dried in two steps: (i) a first drying step directed at removing water and (ii) a second drying step directed at removing water under conditions that simultaneously results in substantial microbial inactivation. The microbial inactivation achieved during the first drying step is generally limited. Thus, for example, dewatered waste activated sludge may be freeze-dried and thereafter exposed to microwave radiation. In preferred embodiments, a first thermal drying step, using, for example, preferably a ring dryer or a spin flash dryer, is followed by a second drying step involving exposure to microwave radiation. Thus the present disclosure further includes a method of processing waste activated sludge obtainable or obtained from an aqueous waste stream comprising microbial cells comprising the steps of:
(a) deactivating the microbial cells to obtain a waste activated sludge substantially free of live microbial cells; and
(b) dewatering the waste activated sludge to reduce the water content of the waste activated sludge to less than about 91% to obtain dewatered waste activated sludge.
   Alternatively, the process of the present invention (instead of steps “a” and “b”), comprises the steps of:
(c) removing water from the waste activated sludge to obtain (I) dewatered waste activated sludge having a water content of 80% or less; or (II) thickened waste activated sludge having a water content of from about 91% to about 96%;
(d) following step (b) or step (c) drying the dewatered or thickened waste activated sludge by a first drying step comprising (i) thermally treating the dewatered waste activated sludge to obtain thermally treated dewatered waste activated sludge, having a water content of less than 80% and a second drying step comprising (ii) treating the thermally treated dewatered waste activated sludge with a means of simultaneously reducing the water content and deactivating the microbial cells to obtain a dried waste activated sludge substantially free of live microbial cells.

Thus following the first thermal treatment step, dewatered activated sludge may be obtained having water content of 80% or less, e.g. about 70%, about 60%, about 50%, about 40% or about 30%. The thermal treatment in the first step is preferably conducted at a temperature of at least 87° C., and more preferably at a temperature between 87° C. and 100° C. An important consideration is that wet material cannot be heated to a temperature in excess of 100° C. until the moisture levels are less than about 20% or less than about 10%. Additionally, wet product in a very hot air stream (for example, up to 315° C.) can be significantly cooler than 100° C. due to evaporative cooling.

In preferred embodiments, the means of simultaneously reducing the water content and deactivating the microbial cells is microwave radiation. Using microwave radiation, the water content of the waste activated sludge may be reduced to, for example, about 10% or less. Drying in two steps, using thermal heating and microwave radiation, is deemed particularly preferred since the present inventors have determined that this allows for the generation of a dried waste activated sludge in which the heat sensitive valuable components (e.g. proteins, vitamins) are preserved to a much larger degree than is possible when either thermal heating alone or microwave heating alone are used to obtain dried waste activated sludge. As hereinbefore mentioned, the thus obtained dried waste activated sludge is additionally substantially free of microbial cells and rich in digestible protein. Thus, using a two-step drying process, WAS preparations having a water content of about 10% or less (e.g. about 9% or less, about 8% or less, about 7% or less, about 6% or less, about 5% or less, about 4% or less, and all values in between), comprising a protein constituent which is about 60% to about 97% (e.g. about 70%, about 75%, about 80%, about 85%, about 90%, about 95%, including all values in between) digestible, and substantially free of microbial cells may be obtained, as further documented in Example 79. The total protein content of the preparations obtained following drying may be as high as about 80% w/w and, more commonly between about 60% and about 67% w/w. Taken together, this renders the dried waste activated sludge product prepared in accordance with this preferred embodiment of the present disclosure particularly suitable as a raw material in the manufacture of end user products, for example, an animal feed product, a human food product or a fertilizer.

In particularly preferred embodiments, a coagulant 180 is mixed with the waste activated sludge. Such coagulant may be mixed either prior to (referring to FIG. 1, methods 101 and 102) or following (referring to FIG. 1, embodiment 103) the application of a means of inactivating the waste activated sludge. Mixing with a coagulant increases the solids content of the waste activated sludge typically up to from about 5% to about 8% (including all values in between), resulting in a water content of the waste activates sludge from about 92% to about 95% (including all values in between). In certain embodiments, the coagulant is added to the waste activated sludge prior to the application of the means of microbe inactivation. Coagulants that may be used in accordance with the present disclosure include, without limitation, any heat stable anionic, non-ionic and cationic polymers, polyacrylamide based polymers, generally recognized as safe (GRAS) polymers, human food-grade polymers and animal feed grade polymers, such as polyacrylamide, where preferably the free acrylamide fraction meets the requirements for feeds and foods such as the GRAS DREWFLOC brand polymers available on the market (e.g. DREWFLOC 2449-GR). Thus in a further aspect, the present disclosure further provides an embodiment of a method of processing waste activated sludge comprising microbial cells obtainable or obtained from an aqueous waste stream comprising the steps of:
(a) deactivating the microbial cells to obtain waste activated sludge substantially free of live microbial cells; and
(b) dewatering the activated sludge to reduce the water content to less than about 91% and obtain dewatered waste activated sludge,

wherein either before or after the performance of step (a) the waste activated sludge is mixed with a coagulant in such a manner that upon mixing of the waste activated sludge with the coagulant, the water content is reduced to from about 95% to about 92%.

In further embodiments of the disclosure where thermal treatment is applied to obtain waste activated sludge substantially free of live microbial cells, the microbial cells present in the waste activated sludge additionally may be lysed. Thus the methods of the present disclosure further include the use of techniques to achieve substantial lysis of the microbial organisms present in waste activated sludge. Cell lysis methodologies are preferably conducted following the application of a means of the thermal treatment of the waste activated sludge, since it has been found by the present inventors that in embodiments hereof where the application of pressure is used to achieve cell lysis, the magnitude of the pressure differential required, is less when using thermally treated cells, thus for example a pressure reduction of as low as about 30 psi may suffice. In other embodiments a pressure reduction of up to about 100 psi, up to about 200 psi or up to about 500 psi may be used, following heat treatment at about 130° C. for about 20 minutes, although in some embodiments, methods to lyse bacterial cells may also be applied prior to the application of the means of thermal treatment. Lysis methodologies that may be used include pressure modulation based lysis techniques. Thus a lysing methodology that may be used in accordance herewith is the so-called French pressure cell press or French press, as hereinbefore detailed.

In at least some embodiments of the present disclosure, preserved waste activated sludge is obtained thus allowing of storage for longer periods of time. For the purpose of the present application, the term “preserved waste active sludge” refers to a preparation of waste activated sludge that is prepared so that the waste activated sludge composition does not undergo undesirable physical or chemical reactions when the composition is stored for longer periods of time, and thus has a commercially acceptable shelf-life. In some embodiments, the waste activated sludge is stable for at least about 1 month. In other embodiments, the preparation is stable for at least about 1 year. In still other embodiments, the preparation is stable for at least about 2 years, all when stored at room temperature. In a further embodiment, the waste activated sludge preparation is prepared so that the preparation can additionally withstand temperature fluctuations such as those which typically may occur in non-temperature controlled environments, for example during transport.

Diagnostic parameters used to assess the stability of the waste activated sludge preparation may be as desired and may include any and all parameters indicative of any and all qualitative or quantitative changes with respect to chemical or physical stability of the waste activated sludge preparation. Typical parameters used to assess alterations in the waste activated sludge over time include color, odor, viscosity, texture, pH, water activity, and microbial growth including molds. In particular embodiments, changes in the waste activated sludge preparation with respect to these parameters are minimal, e.g. less than about 10%, or substantially absent.

Undesirable alterations in the waste activated sludge preparation of the present disclosure may be caused by any agent or governed by any underlying physical or chemical principle. Undesirable reactions include for example oxidative reactions, typically caused by the exposure to air, and alterations resulting from radiation induced reactions, typically the exposure to light. In addition, undesirable chemical alterations are meant to include alterations caused by biological agents such as bacteria, fungi, mycoplasmas, viruses, and the like. These agents may remain present in very low levels following the performance of the process steps in accordance herewith or they may be reintroduced into the waste activated sludge upon storage. The present invention is not meant to be limited with respect to the causative agent responsible for the alteration or underlying chemical or physical principle governing the alterations.

In a further aspect, the present disclosure provides in one embodiment a method of processing waste activated sludge comprising microbial cells obtainable or obtained from an aqueous waste stream, comprising the steps of:
(a) removing water from the waste activated sludge to obtain (I) dewatered waste activated sludge having a water content of 80% or less; or (II) thickened waste activated sludge having a water content of from about 91% to about 96%; a
(b) deactivating the microbial cells to obtain a waste activated sludge substantially free of live microbial cells; and
(c) preserving the dewatered waste activated sludge or thickened waste activated sludge by mixing the dewatered waste activated sludge or thickened waste activated sludge with a compound selected from the group of compounds consisting of acid, base or binding water to obtain preserved waste activated sludge.
   Alternatively, the process of the present invention (instead of steps “a”, “b”, and “c”) comprises the step of:
(d) drying the dewatered waste active sludge or thickened waste activated sludge and preserving the dried waste activated sludge with a compound selected from the group of compounds consisting of acid, base, or binding water to obtain preserved waste activated sludge.

Referring again to FIG. 1, the foregoing provides for preservation of waste activated sludge processed in accordance with methods 101 and 102. In accordance with the present disclosure, method 103 also may yield preserved waste activated sludge. Thus the present disclosure further comprises a method of processing waste activated sludge comprising microbial cells obtainable or obtained from an aqueous waste stream comprising the steps of:
(a) deactivating the microbial cells to obtain a waste activated sludge substantially free of live microbial cells;
(b) dewatering the waste activated sludge to reduce the water content of the waste activated sludge to less than about 91% to obtain dewatered waste activated sludge;
(c) drying the dewatered waste activated sludge; and
(d) preserving the dried waste activated sludge with a compound selected from the group of compounds consisting of acid, base or binding water to obtain preserved waste activated sludge.

In accordance herewith in one embodiment, once dewatered waste activated sludge or thickened waste activated sludge has been obtained, it is contacted with a compound selected from the group of compounds consisting of an acid, a base or binding water, and mixed to obtain preserved waste activated sludge. Acids that may be used in accordance herewith include hydrochloric acid, sulfuric acid, or nitric acid and are provided in such a manner that the final concentration of hydrogen ions ([H⁺]) in the waste activated sludge varies from about 10⁻¹ to about 10⁻⁵ molar. Bases that may be used in accordance herewith include sodium hydroxide, calcium hydroxide, potassium hydroxide and are provided in such a manner that the final [H⁺] in the waste activated sludge varies from about 10⁻⁹ to about 10^{-13.5} molar. Compounds that may be used to bind water are humectants such as polyethylene glycol, glycerol, and sorbitol. Further preservative agents may be included in the waste activated sludge including bactericidal agents and fungicidal agents. These agents include but are not limited to propionic acid and salts thereof, benzoic acid and salts thereof, sorbic acid and salts thereof, fumaric acid and salts thereof, acetic acid and salts thereof, lactic acid and salts thereof, other organic acids including mixtures thereof, gentian violet, lactic acid producing bacteria, antifungals such as natamycin (also known as pimaricin), amphotericin, and other antifungal antibiotics.

In one aspect, the present disclosure also provides a waste activated sludge that is sterile to a commercially acceptable level and comprises at least about 70% digestible protein.

In a further aspect the present disclosure also provides a composition comprising dried activated sludge that is sterile to a commercially acceptable level and has a moisture content of less than about 20%, and comprises at least about 70% digestible protein.

In a further aspect, the present disclosure also provides a composition comprising preserved dried activated sludge that is sterile to a commercially acceptable level and has a moisture content of less than about 20% or about 10%, and comprises at least about 70% digestible protein.

In accordance herewith in some embodiments, the waste activated sludge obtained following the inactivation of microbial cells may be used as a source material to enrich certain microbial cellular fractions (referring to FIG. 1, reference character 155), including, without limitation microbial cell membranes, cytoplasmic cellular material, microbial lipids, microbial nucleic acids, specific pure proteins, specific pure vitamins, polysaccharides, including mannans and beta-glucans, oils, or other valuable components that may be obtained in more or less pure form from the bacterial cells following extraction and purification methodologies applied to the microbial cell mass. Such methodologies include for example solvent extraction methodologies and purification, including protein purification methodologies such as membrane filtration, column chromatography, high performance liquid chromatography, precipitation, and other methodologies. Upon extraction further techniques may be used to prepare a product, including drying (e.g. drying to obtain dried microbial cell membranes) and the inclusion of humectants and other formulants to prepare formulated waste activated sludge fractions.

Of specific interest are protein and oil concentrates obtainable from waste activated sludge obtained in accordance with the present disclosure. Thus further included herein are protein or oil concentrates obtained following extraction of the waste activated sludge of the present invention and methods of obtaining such protein or oil concentrates using solvent extraction or supercritical extraction. Accordingly the present invention further includes a method of obtaining a protein or oil concentrate comprising processing waste activated sludge comprising microbial cells having a water content of at least about 97%, obtainable or obtained from an aqueous waste stream by
(a) deactivating the microbial cells to obtain a waste activated sludge substantially free of live microbial cells; and
(b) dewatering the waste activated sludge to reduce the water content of the waste activated sludge to less than about 91% to obtain dewatered waste activated sludge
   Alternatively, the process of the present invention (instead of steps “a” and “b”), comprises the steps of:
(c) dewatering the waste activated sludge to reduce the water content of the waste activated sludge to less than about 80% to obtain dewatered waste activated sludge; and
(d) deactivating the microbial cells to obtain a waste activated sludge substantially free of live microbial cells; and
(e) obtaining a protein or oil concentrate from the waste activated sludge.

In accordance herewith, the compositions provided herein may be used as a raw material to prepare products (referring to FIG. 1, reference character 150). The waste activated sludge and waste activated sludge fractions are particularly useful to prepare nutritious animal feed products in view of the high protein content and the high concentration of non-denatured protein in the waste activated sludge. Thus the waste activated sludge and waste activated sludge fractions provided in accordance with the methodologies provided herein may be used to prepare a nutritious feed for terrestrial animals, e.g. cattle, pork, poultry, as well as a feed for aquatic animals, including vertebrate aquatic animals and invertebrates, e.g. shrimp. The waste activated sludge product and waste activated sludge fractions may be used without further formulation as a single ingredient animal feed product, or more preferably may be formulated together with other nutritional ingredients and other formulants (e.g. humectants) to prepare a multi-ingredient animal feed product. The product may be prepared in any consistency and may for example be prepared in the form of pellets. The waste activated sludge product further may be used as an ingredient to prepare a nutritious human food product or as a fertilizer, as further shown in Example 81 and 82. The fertilizer may comprise dried cells, inactivated dried cells, inactivated wet cells, lysed cells, cytoplasm, or peptides.

The present disclosure is further described by reference to the following examples which are illustrative and not intended to limit the disclosure.

### EXAMPLES

### Example 1

### Heat Treatment of Waste Activated Sludge

An aqueous waste stream containing BOD, nutrients, and dissolved oxygen is aerated in a tank or basin to produce a cellular biomass. This biomass is then separated from the bulk water in a clarifier, dissolved air flotation system, membrane filter, or other means, a portion of it is returned to the aerobic basin, and a portion of it is removed from the system as waste activated sludge. This waste activated sludge is then heated to a temperature of about 121° C. to about 155° C. within an enclosed pressure vessel to produce a commercially sterile waste activated sludge.

### Example 2

### Heat Treatment of Waste Activated Sludge

An aqueous waste stream obtained from a beverage production plant, a potato processing plant, a corn processing plant, a sugar processing plant, a citrate producing plant, a yeast manufacturing plant, a meat rendering plant or a dairy production plant is treated as disclosed in Example 1.

### Example 3

### Heat Treatment of Waste Activated Sludge

An aqueous waste stream from a beverage production plant such as a beer brewery, a distillery, a palm oil mill, or a fruit juice production facility is treated as disclosed in Example 1.

### Example 4

### Heat Treatment of Waste Activated Sludge

The waste activated sludge of Example 1 is heated using a heat exchanger to a temperature of about 10-30° C. to at least about 121° C.

### Example 5

### Heat Treatment of Waste Activated Sludge

The waste activated sludge of Example 1 is heated in a liquid-to-liquid heat exchanger or a gas-to-liquid heat exchanger to a temperature of about 10-30° C. to at least about 121° C.

### Example 6

### Heat Treatment of Waste Activated Sludge—Addition of Coagulant

The commercially sterile waste activated sludge of Example 1 is cooled to a temperature between about 66° C.-93° C. prior to the addition of a coagulation polymer. (Temperatures of higher than about 93° C. can cause hydrolysis of the coagulant polymer.)

### Example 7

### Heat Treatment of Waste Activated Sludge—Addition of Coagulant

The commercially sterile waste activated sludge of Example 6 is cooled to a temperature that allows the coagulation polymer to function properly and without excessive hydrolysis that is indirectly observed as a decrease in coagulation efficacy.

### Example 8

### Heat Treatment of Waste Activated Sludge—Addition of Coagulant

The process of Example 6, where said coagulation polymer is food grade or generally recognized as safe (GRAS) as described herein.

### Example 9

### Heat Treatment of Waste Activated Sludge—Addition of Coagulant

The process of Example 6, where the commercially sterile waste activated sludge is cooled to a temperature that does not adversely affect the operation of a separation device used subsequently. For example, commercially sterile waste activated sludge cooled to a temperature of 93° C. does not interfere with the coagulation efficiency of the coagulation polymer, or the performance of centrifuges or other dewatering devices.

### Example 10

### Heat Treatment of Waste Activated Sludge—Addition of Coagulant

The process of Example 9, where said separation device is a centrifuge, membrane, or other type of filter.

### Example 11

### Dewatering Waste Activated Sludge

The process of Example 1, where said commercially sterile waste activated sludge is subsequently separated from the aqueous stream using a centrifuge, membrane, or other type of filter to produce a dewatered activated sludge that is commercially sterile.

### Example 12

### Dewatering and Drying Waste Activated Sludge

The process of Example 11, where the dewatered waste activated sludge is then thermally dried in a dryer, for example any of the driers described herein.

### Example 13

### Dewatering and Drying Waste Activated Sludge

The process of Example 12, where said dryer is a drum dryer, superheated steam dryer, ring dryer, flash dryer, swirl fluidizer dryer, thin-film dryer, or spray dryer.

### Example 14

### Dewatering and Drying Waste Activated Sludge

The process of Example 12, where said dryer produces a dried, commercially sterile, waste activated sludge with a water content of about 10% water.

### Example 15

### Preparation of Feed and Food Form Waste Activated Sludge

The process of Examples 1-14, where said commercially sterile waste activated sludge is used to prepare an animal feed or human food.

### Example 16

### Preparation of a Fertilizer from Waste Activated Sludge

The process of Examples 1-14, where said commercially sterile waste activated sludge is used to prepare a fertilizer.

### Example 17

### Production of a Dried Waste Activated Sludge

An aqueous waste stream containing BOD, nutrients, and dissolved oxygen is aerated in a tank or basin to produce a cellular biomass. This biomass is then separated from the bulk water in a clarifier, dissolved air flotation system, membrane filter, or other means, a portion of it is returned to the aerobic basin, a portion of it is removed from the system as waste activated sludge and dewatered to produce a dewatered waste activated sludge. Said dewatered activated sludge is then thermally dried in a thin-film dryer or other dryer suitable for drying viscous materials such as pastes, gels, or thick suspensions to produce a dried waste activated sludge.

### Example 18

### Production of a Dried Commercially Sterile Waste Activated Sludge

The process of Example 17, where said dried waste activated sludge is then irradiated to inactivate the cellular material and obtain dried commercially sterile waste activated sludge.

### Example 19

### Production of a Dried Commercially Sterile Waste Activated Sludge

As disclosed in Example 18, where said radiation is electrical (such as the e-beam process), gamma (such as the radiation emitted by cobalt 60), or microwaves.

### Example 20

### Production of a Dried Commercially Sterile Waste Activated Sludge

The process of Example 19, where said microwaves have a frequency between about 800 MHz and about 2450 MHz.

### Example 21

### Production of a Dried Commercially Sterile Waste Activated Sludge

The process of Example 19, where said microwaves have a frequency between about 900 MHz to about 1000 MHz.

### Example 22

### Dewatering of Waste Activated Sludge followed by Sterilization

An aqueous waste stream containing BOD, nutrients, and dissolved oxygen is aerated in a tank or basin to produce a cellular biomass. This biomass is then separated from the bulk water in a clarifier, dissolved air flotation system, membrane filter, or other means, a portion of it is returned to the aerobic basin, a portion of it is removed from the system as waste activated sludge and dewatered to produce a dewatered waste activated sludge. Said dewatered waste activated sludge is then biologically inactivated thermally or by radiation to obtain commercially sterile waste activated sludge.

### Example 23

### Dewatering of Waste Activated Sludge followed by Sterilization

The process of Example 22, where the dewatered waste activated sludge is biologically inactivated with superheated steam dryers, ring dryers, flash dryers, swirl fluidizers, or other dryers that provide a temperature adequate to inactivate microorganisms and a residence time short enough to preserve protein structure and digestibility. While particular combinations of residence time and temperature are optimal for a particular dryer and protein composition, and which preserve heat-labile proteins and inactivate the microorganisms, generally either lower temperatures (e.g., about 55° C. to about 75° C.) and higher residence times (e.g., about 12to about 24 hours), or higher temps (e.g., about 230° C. to about 260° C.) and lower times (e.g., about 1/30 to about ⅙ hours) are suitable. For example, a residence time of about 12 hours in an oven operating at 65° C. is often sufficient to inactivate microorganisms and preserve protein quality and digestibility. Example 78 shows the digestibility changes in the product when using a ring dryer with varying inlet temp.

### Example 24

### Dewatering of Waste Activated Sludge followed by Sterilization

The process of Example 22, where the dewatered waste activated sludge is biologically inactivated with gamma radiation, e-beam radiation, or microwaves to produce an irradiated waste activated sludge.

### Example 25

### Dewatering of Waste Activated Sludge followed by Sterilization and Drying

The process of Example 24, where irradiated waste activated sludge is then dried.

### Example 26

### Dewatering of Waste Activated Sludge followed by Sterilization and Drying

The process of Example 25, where the sludge is dried in superheated steam dryers, ring dryers, flash dryers, swirl fluidizers, or other dryers that provide a temperature adequate to inactivate microorganisms and a residence time short enough to preserve protein structure and digestibility.

### Example 27

### Dewatering of Waste Activated Sludge followed by Sterilization

The process of Example 22, where said waste active sludge is inactivated by exposure to a pressure drop, ultrasonic cavitation, enzymatic digestion, or other methods of lysing cellular membranes.

### Example 28

### Dewatering of Waste Activated Sludge followed by Sterilization

The process of Example 27, where the deactivation is carried out by utilizing a pressure drop, which occurs by pressurizing the dewatered waste activated sludge and then forcing it through a small orifice such that the pressure drops to the ambient level after passing through said orifice such as occurs in mechanisms referred to as homogenizers or French Presses.

### Example 29

### Fractionation of Commercially Sterile Waste Activated Sludge

The process of Example 28, where said lysed and sterilized waste activated sludge is further separated into cell membranes and cytoplasm.

### Example 30

### Fractionation of Commercially Sterile Waste Activated Sludge, and Use to Prepare Feed, Food or Fertilizer

The process of Example 29, where said cell membranes are then dried and used to prepare feeds for animals, food for humans, or as a fertilizer.

### Example 31

### Fractionation of Commercially Sterile Waste Activated Sludge, and Use to Prepare Feed, Food or Fertilizer

The process of Example 30, where said cell membranes are dried in a drum dryer, superheated steam dryer, ring dryer, flash dryer, swirl fluidizer dryer, thin-film dryer, or spray dryer.

### Example 32

### Fractionation of Commercially Sterile Waste Activated Sludge

The process of Example 29, where acid, base, or a humectant is added to said cell membranes to produce a preserved cell membrane suspension.

### Example 33

### Fractionation of Commercially Sterile Waste Activated Sludge, and Use to Prepare Feed, Food or Fertilizer

The process of Example 32, where said cell membrane suspension is used to prepare feeds for animals or food for humans by blending with other ingredients and processing to the desired form. For example, the blended ingredients may be pelleted to form an animal feed or extruded to form a desired shape. The cell membrane suspension may also be used as a fertilizer merely by adding it to soil or other growth media.

### Example 34

### Fractionation of Commercially Sterile Waste Activated Sludge and Use to Prepare Feed, Food or Fertilizer

The process of Example 29, where said cytoplasm is dried and used to prepare feeds for animals or food for humans, or as a fertilizer.

### Example 35

### Fractionation of Commercially Sterile Waste Activated Sludge

The process of Example 29, where acid, base, or a humectant is added to said cytoplasm to produce a preserved cytoplasm.

### Example 36

### Fractionation of Commercially Sterile Waste Activated Sludge and Use to Prepare Feed, or Fertilizer

The process of Example 35, where said preserved cytoplasm is used in feeds for animals or as a fertilizer.

### Example 37

### Fractionation of Commercially Sterile Waste Activated Sludge and Use to Prepare Feed, or Fertilizer

The process of Example 35, where said preserved cytoplasm is used as a human food.

### Example 38

### Fractionation of Commercially Sterile Waste Activated Sludge

The process of Example 29, where said cell membranes are further processed using solvent extraction techniques, alcohol precipitation, or other methods to isolate or concentrate components of the cellular membrane such as proteins, lipids, vitamins, coenzymes, to produce a peptide mixture, or to produce other nutritional components.

### Example 39

### Fractionation of Commercially Sterile Waste Activated Sludge and Use to Prepare Feed, or Fertilizer

The process of Example 37, where said cell membrane components are used in feeds for animals, food for humans, or as a fertilizer.

### Example 40

### Fractionation of Commercially Sterile Waste Activated Sludge and Use to Prepare Feed, or Fertilizer

The process of Example 38, where said cell membranes after component extraction are used in feeds for animals, food for humans, or as a fertilizer.

### Example 41

### Fractionation of Commercially Sterile Waste Activated Sludge and Use to Prepare Feed, or Fertilizer

The process of Example 40, where said cellular membranes after component extraction are dried.

### Example 42

### Fractionation of Commercially Sterile Waste Activated Sludge and Use to Prepare Feed, or Fertilizer

The process of Example 41, where said drying occurs in a drum dryer, superheated steam dryer, ring dryer, flash dryer, swirl fluidizer dryer, thin-film dryer, or spray dryer.

### Example 43

### Fractionation of Commercially Sterile Waste Activated Sludge and Use to Prepare Feed, or Fertilizer

The processes of Examples 40-42, where said cellular membranes after component extraction are used in the preparation of feed for animals, food for humans, or as a fertilizer.

### Example 44

### Fractionation of Commercially Sterile Waste Activated Sludge

The process of Example 29, where said cytoplasm is further processed using ethanol precipitation methods, membrane filtration methods, or other methods to isolate components of the cytoplasm.

### Example 45

### Fractionation of Commercially Sterile Waste Activated Sludge

The process of Example 44, where said components include nucleic acids, proteins, coenzymes, lipids, or vitamins.

### Example 46

### Fractionation of Commercially Sterile Waste Activated Sludge

The process of Example 45, where said nucleic acids, proteins, coenzymes, lipids, or vitamins are used in feeds for animals, food for humans, or as a fertilizer.

### Example 47

### Fractionation of Commercially Sterile Waste Activated Sludge

The process of Example 44, where said cytoplasm after component isolation and removal is used in feeds for animals, food for humans, or as a fertilizer.

### Example 48

### Fractionation of Commercially Sterile Waste Activated Sludge

The process of Example 29, where said separation occurs through the use of centrifuges or membrane filters.

### Example 49

### Fractionation of Commercially Sterile Waste Activated Sludge

The processes of Examples 29 and 44, and 47, where said cytoplasm is dried using a spray dryer or similar.

### Example 50

### Fractionation of Commercially Sterile Waste Activated Sludge and Use to Prepare Feed, Food or Fertilizer

The process of Example 29, where said cytoplasm is used as in feeds for animals, food for humans, or as a fertilizer.

### Example 51

### Dewatering Waste Activated Sludge

The process of Example 11, where a strong acid or strong base is added to said dewatered activated sludge that is commercially sterile to produce an inactivated commercially sterile dewatered waste activated sludge.

### Example 52

### Dewatering Waste Activated Sludge

The process of Example 51, where a humectant is added to said dewatered activated sludge that is commercially sterile to produce a commercially sterile waste activated sludge with a low activity of water.

### Example 53

### Dewatering Waste Activated Sludge

The process of Example 51, where a humectant is added to said dewatered activated sludge that is commercially sterile to produce a dewatered commercially sterile waste activated sludge with a low activity of water.

### Example 54

### Dewatering Waste Activated Sludge

The process of Examples 51-53 where said commercially sterile waste activated sludge with a low activity of water and said inactivated commercially sterile dewatered waste activated sludge is used in feeds for animals, food for humans, or as a fertilizer.

### Example 55

### Dewatering Waste Activated Sludge

The process of Example 11, where said dewatered commercially sterile waste activated sludge is subjected to a pressure drop, ultrasonic cavitation, or enzymatic digestion to produce a lysed dewatered commercially sterile waste activated sludge.

### Example 56

### Dewatering Waste Activated Sludge

The process of Example 55, where said lysed dewatered commercially sterile waste activated sludge is dried to produce a dried lysed commercially sterile waste activated sludge.

### Example 57

### Dewatering Waste Activated Sludge

The process of Example 56, where said drying occurs in a drum dryer, superheated steam dryer, ring dryer, flash dryer, swirl fluidizer dryer, thin-film dryer, or spray dryer.

### Example 58

### Dewatering Waste Activated Sludge to Prepare Feed, Food or Fertilizer

The process of Example 56, where said dried lysed commercially sterile waste activated sludge is used in feeds for animals, food for humans, or as a fertilizer. Example 59. Dewatering waste activated sludge The process of Example 56, where said lysed dewatered commercially sterile waste activated sludge is amended with a strong acid or strong base to produce an inactivated lysed dewatered commercially sterile waste activated sludge. The addition of acid or base creates a pH environment that retards the growth of microorganisms, which improves the stability of the feed, food, or fertilizer. The amount of acid or base required will depend on the characteristics of the composition(e.g., its buffering capacity). A non-limiting list of acids or bases suitable for use in food products include hydrochloric, nitric, or sulfuric acid, and sodium, potassium, or calcium hydroxide, whereby a final pH of about 3 or lower (e.g., about 3, 2.5, or 2), or about 9 or higher (e.g., about 9, 9.5, or 10) is obtained.

### Example 60

### Dewatering Waste Activated Sludge

The process of Example 56, where said lysed dewatered commercially sterile waste activated sludge is amended with a humectant (as described above) to produce a lysed dewatered commercially sterile waste activated sludge with a low activity of water (as described above).

### Example 61

### Dewatering Waste Activated Sludge

The process of Example 56, where said lysed dewatered commercially sterile waste activated sludge is amended with a strong acid or a strong base (as described above) and a humectant (as described above) to produce an inactivated lysed dewatered commercially sterile waste activated sludge with a low activity of water (as described above).

### Example 62

### Dewatering Waste Activated Sludge

The process as disclosed in Examples 59-61 where said inactivated lysed dewatered commercially sterile waste activated sludge and lysed dewatered commercially sterile waste activated sludge with a low activity of water (e.g. less than about 0.5, for example about 0.25 a_{w}) and said inactivated lysed dewatered commercially sterile waste activated sludge with a low activity of water is used in feeds for animals, food for humans, or as a fertilizer.

### Example 63

### Dewatering Waste Activated Sludge and Preparation of Fractions thereof

The processes of Examples 51 and 56, where said commercially sterile and lysed waste activated sludge and said lysed dewatered commercially sterile waste activated sludge are then subjected to separation technologies such as centrifugation that allow the separation of the cell membranes and the cytoplasm. Said membranes may then be used in feeds for animals, food for humans, or as a fertilizer. Said membranes may also be dried and in feeds for animals, food for humans, or as a fertilizer. Said drying may occur in a drum dryer, superheated steam dryer, ring dryer, flash dryer, swirl fluidizer dryer, thin-film dryer, or spray dryer. Said membranes may also be amended with strong acid or strong base or a humectant and used in feeds for animals, food for humans, or as a fertilizer. Said membranes may also be amended with a strong acid or strong base and a humectant and used in feeds for animals, food for humans, or as a fertilizer. Said membranes may also be subjected to extractions methods such as solvent extraction to purify, for example, phospholipids from the membranes. Said membranes subsequent to extraction methods may be used in feeds for animals, food for humans, or as a fertilizer. Said membranes subsequent to extraction methods may also be dried and then used in feeds for animals, food for humans, or as a fertilizer. Said drying may occur in a drum dryer, superheated steam dryer, ring dryer, flash dryer, swirl fluidizer dryer, thin-film dryer, or spray dryer. Said extracted products, including phospholipids may be used in feeds for animals, food for humans, or as a fertilizer.

### Example 64

### Dewatering Waste Activated Sludge and Preparation of Fractions thereof

The processes of Examples 51 and 56, where said commercially sterile and lysed cellular suspension and said lysed dewatered commercially sterile waste activated sludge are then subjected to separation technologies such as centrifugation that allow the separation of the cell membranes and the cytoplasm. Said cytoplasm may then be used in feeds for animals, food for humans, or as a fertilizer. Said cytoplasm can also be subjected to purification and precipitation methodologies such as for example, alcohol precipitation to produce for example, protein concentrates or purified nucleic acids. Said cytoplasm subsequent to said purification or extraction methodologies can then be used in feeds for animals, food for humans, or as a fertilizer. Said purified products such as, for example, proteins or nucleic acids can then be used in feeds for animals, food for humans, or as a fertilizer. Said cytoplasm can be dried in a drum dryer, superheated steam dryer, ring dryer, flash dryer, swirl fluidizer dryer, thin-film dryer, or spray dryer to produce a material that can be used in feeds for animals, food for humans, or as a fertilizer. A strong acid, strong base, or a humectant can also be added to said cytoplasm to produce an inactivated cytoplasm, an inactivated cytoplasm with a low activity of water, or a cytoplasm with a low activity of water. Said inactivated cytoplasm, an inactivated cytoplasm with a low activity of water, or a cytoplasm with a low activity of water can then be used in feeds for animals, food for humans, or as a fertilizer.

### Example 65

### Production of a Dewatered and Lysed Inactivated Sludge

An aqueous waste stream containing BOD, nutrients, and dissolved oxygen is aerated in a tank or basin to produce a cellular biomass. This biomass is then separated from the bulk water in a clarifier, dissolved air flotation system, membrane filter, or other means, a portion of it is returned to the aerobic basin, a portion of it is removed from the system as waste activated sludge and dewatered to produce a dewatered waste activated sludge. Said dewatered activated sludge is then subjected to a pressure drop, ultrasonic cavitation, or enzymatic digestion to produce a lysed dewatered waste activated sludge.

### Example 66

### Production of a Dewatered and Lysed Inactivated Sludge

The process of Example 65, where a strong acid, a strong base, or a humectant is added to said lysed dewatered waste activated sludge to produce an inactivated lysed waste activated sludge.

### Example 67

### Production of a Dewatered and Lysed Inactivated Sludge

The process of Example 65, where a strong acid or a strong base and a humectant is added to said lysed dewatered waste activated sludge to produce an inactivated lysed waste activated sludge having a pH of about 2-3 or 9-10, with a low activity of water (e.g., about 0.25 a_{w}).

### Example 68

### Production of a Dewatered and Lysed Inactivated Sludge

The process of Example 65, where a humectant is added to said lysed dewatered waste activated sludge to produce a lysed dewatered waste activated sludge with a low activity of water.

### Example 69

### Production of a Dewatered and Lysed Inactivated Sludge

The processes of Examples 65-68, where said lysed dewatered waste activated sludge, said inactivated lysed waste activated sludge, or said inactivated lysed waste activated sludge with a low activity of water is irradiated to produce an irradiated lysed dewatered waste activated sludge, an irradiated inactivated lysed waste activated sludge, or an irradiated inactivated lysed waste activated sludge with a low activity of water.

### Example 70

### Production of a Dewatered and Lysed Inactivated Sludge

The process of Example 69, where said radiation includes gamma radiation, e-beam radiation, or microwaves.

### Example 71

### Production of a Dewatered and Lysed Inactivated Sludge

The processes of Example 65, 66 or 67, where said lysed dewatered waste activated sludge, said inactivated lysed waste activated sludge, or said inactivated lysed waste activated sludge with a low activity of water, is dried.

### Example 72

### Production of a Dewatered and Lysed Inactivated Sludge

The process of Example 71, where said drying occurs in a drum dryer, superheated steam dryer, ring dryer, flash dryer, swirl fluidizer dryer, thin-film dryer, or spray dryer.

### Example 73

### Production of a Dewatered and Lysed Inactivated Sludge to Prepare Feed, Food or Fertilizer

The processes of Examples 65-69 and 71-72, where said lysed dewatered waste activated sludge, said inactivated lysed waste activated sludge, said inactivated lysed waste activated sludge with a low activity of water, said lysed dewatered waste activated sludge with a low activity of water, said irradiated lysed dewatered waste activated sludge, said irradiated inactivated lysed waste activated sludge, said irradiated inactivated lysed waste activated sludge with a low activity of water, or a dried form of the above is used as an ingredient in feeds for animals, food for humans, or as a fertilizer.

### Example 74

### Protein Digestibility of Waste Activated Sludge Subjected to Heat Treatment

An aqueous waste stream from a brewery containing BOD, and nutrients was continuously supplied to an aerated tank to produce a cellular biomass. This biomass was then separated from the bulk water in a gravity clarifier, a portion of it was returned to the aerobic basin, and a portion of it was removed from the system as waste activated sludge comprised of approximately 2% solids. This waste activated sludge was then heated to 121° C. for 20 minutes in order to achieve microbial inactivation as shown below, centrifuged to produce a dewatered waste activated sludge, and then dried at 65° C. until the moisture content was less than 10%, and as further shown in embodiment 103 in FIG. 1. The digestibility of the individual amino acids was then measured using Novus International's IDEA soybean meal digestibility assay and was compared to the digestibility of a control sample that was centrifuged to produce a dewatered waste activated sludge dried at 65° C. until the moisture content was less than 10%, and was not heated to 121° C. The results shown in Table 2 below show a general unexpected increase in amino acid digestibility as measured by Novus' IDEA assay, despite heat treatment of the waste activated sludge.

TABLE 2
Protein Digestibility of Heat Treated Waste Activated Sludge

| | Waste activated control | Waste activated sludge |
|---|---|---|
| | (no heat treatment; | heated to 121° C.; |
| | IDEA digestibility | IDEA digestibility |
| Amino Acid | value^{a}) | value |
| IDEA Alanine | 65 | 69 |
| IDEA Arginine | 74 | 77 |
| IDEA Aspartic Acid | 35 | 39 |
| IDEA Cystine | 35 | 35 |
| IDEA Glutamic Acid | 58 | 62 |
| IDEA Glycine | 69 | 72 |
| IDEA Histidine | 49 | 55 |
| IDEA Isoleucine | 48 | 57 |
| IDEA Leucine | 53 | 61 |
| IDEA Lysine | 35 | 35 |
| IDEA Methionine | 45 | 54 |
| IDEA Phenylalanine | 70 | 73 |
| IDEA Proline | 64 | 68 |
| IDEA Serine | 55 | 60 |
| IDEA Threonine | 45 | 54 |
| IDEA Tryptophan | 73 | 77 |
| IDEA Tyrosine | 74 | 77 |
| IDEA Valine | 56 | 61 |

^{a}higher value corresponds to greater digestibility

### Example 75

### Effects of Drying on the Digestibility of Waste Activated Sludge

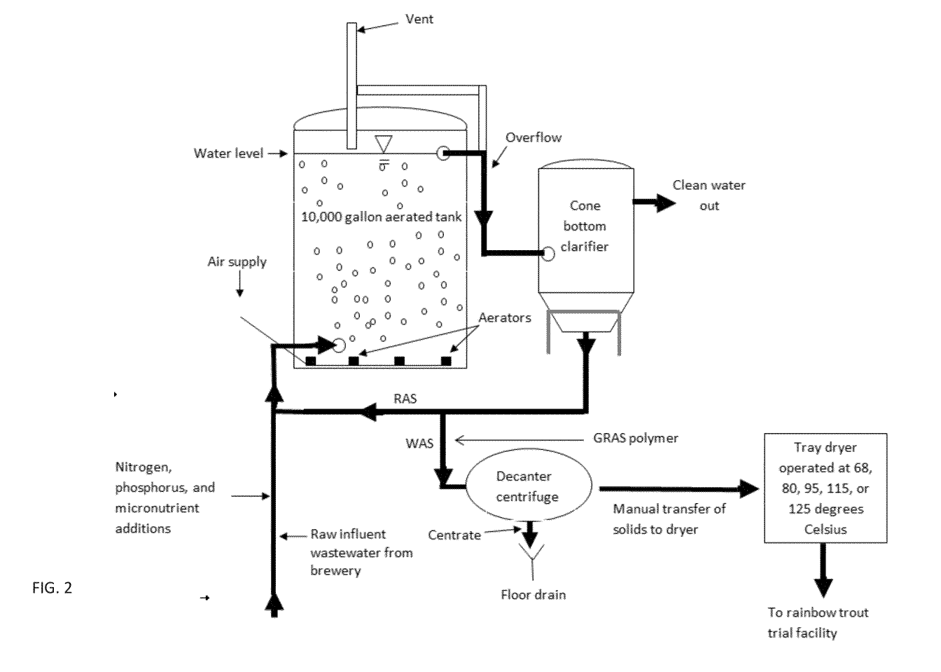

An aqueous waste stream from a brewery containing BOD, and nutrients was continuously supplied to an aerated tank to produce a cellular biomass. Overflow from the aerated tank was piped by gravity to a cone bottom tank that acted as a gravity clarifier. A portion of the settled sludge in this clarifier was returned to the aerated tank as return activated sludge and another portion was removed from the system as a waste activated sludge that was comprised of approximately 2% solids. A food grade polymer (examples?) was added to this waste activated sludge as it was piped to a decanter centrifuge and dewatered to contain approximately 16% solids and 84% water. The resulting dewatered waste activated was then dried on metal pans in a tray drier for a period of approximately 12 hours at temperatures of about 68° C., about 80° C., v95° C., v110° C., and about 125° C. as shown in Table 3. The foregoing process comprises method 101 as shown in FIG. 1 and is further illustrated in FIG. 2. After drying, the resulting material was removed from the pans and ground to a particle size of 0.5 mm or less using a roller mill. A subsample of the material dried at about 68° C. was removed and crude protein was analyzed using a Leco FP428 protein analyzer. Rainbow trout diets were then prepared that included these dried samples to determine the digestibility of the protein, lipid, and energy fractions of these differentially dried materials. To do so, six diets were manufactured. One of these was a casein-gelatin reference diet and four contained 30% of the differentially dried waste activated sludge and 70% of the casein-gelatin control diet as shown below:

1. Casein-gelatin control diet

2. Casein control with waste activated sludge dried at 68° C.

3. Casein control with waste activated sludge dried at 80° C.

4. Casein control with waste activated sludge dried at 95° C.

5. Casein control with waste activated sludge dried at 110° C.

6. Casein control with waste activated sludge dried at 125° C.

To each diet, an indigestible inert marker (yttrium oxide) was included at 0.01%. Pellet size was about 3 mm. To determine the digestibility of the waste activated sludge products by rainbow trout the analyses of the SCP diets were compared to the analyses of the control diet and the relevant calculation was made according to the methods (see below).

Diets were made by extrusion. Samples of each diet were taken for proximate, amino acid, mineral and yttrium analyses. Diets were assigned randomly to three replicate tanks within a fish-rearing laboratory.

Fish maintenance and feeding regime: Post-juvenile rainbow trout were used in this study (150 g fish⁻¹). At stocking, rainbow trout were counted into groups of 20 and placed into 150-L tanks until each tank contained 60 fish. There were 2 treatments, with three replicate tanks of fish for each treatment, for a total of 6 experimental tanks Each tank was supplied with untreated, constant temperature (15° C.) spring water at a flow rate of 6-L per minute. Photoperiod was maintained at a constant 14 h light; 10 h dark with fluorescent lights.

Fish were fed their respective diets twice daily, at 0830-0900 h and 1530-1600 h to apparent satiation for one week. Then feces were then collected by manual stripping from each fish. Fecal material from fish within each tank was be pooled, and then each tank's feces was analyzed separately.

Chemical analyses: The dried waste activated sludge ingredient, 2 diets and 6 fecal samples were dried in a convection oven at 105° C. for 12 h to determine moisture level according to AOAC (1990). Dried samples were finely ground by mortar and pestle and analyzed for crude protein (total nitrogen×6.25) using a LECO FP-428 nitrogen analyzer (LECO Instruments, St. Joseph, Mich.). Crude lipid was analyzed using a soxhlet extraction apparatus (Soxtec System HT, Foss Tecator AB, Hoganas, Sweden) with methylene chloride as the extracting solvent, and ash by incineration at 550° C. in a muffle furnace. Energy content of samples were determined using a Parr Adiabatic Calorimeter (Parr Instruments, Moline, Ill.). Amino acids were analyzed at an accredited third-party lab using an HPLC (excluding tryptophan). Analyses of minerals & yttrium was conducted by the University of Idaho, Holm Center, Moscow, Idaho.

Calculations of apparent digestibility coefficients of diets and test ingredients: Apparent digestibility coefficients (ADC), for both diets and ingredients, for dry matter, organic matter, protein, amino acids, lipid, energy and minerals were calculated using the following formulae described by Sugiura et al. (1998):

### Step 1. Diet ADC:

ADC_{test diet}(%)=100×[1−(% marker in diets/% marker in feces)×(% nutrient in feces/% nutrient in diets)]

### Step 2: Ingredient ADC:

ADC_{ingredient}(%)=(Nutrient_{test diet}×ADC_{test diet}−0.7×Nutrient_{reference diet}×ADC_{reference diet})/(0.3×Nutrient_{test ingredient})

Statistical analyses: Homogeneity of variances were assessed using Cochran's C Test. ADCs for dry matter, organic matter, protein, amino acids, lipid, energy, lipid and mineral ADCs for diets and ingredient were compared using One-way Analysis of Variance (ANOVA). Means was considered significant at P<0.05.

### Results:

Control (dried at 68° C.) protein content: 62.17%

Apparent digestibility and availability coefficients (%) of dry matter, crude protein, lipid, energy, and phosphorus in rainbow trout fed waste activated sludge dried at different temperatures (see: Table 3). Menhaden fish meal (Select grade) ADC values for protein and energy are 86% and 96%, respectively.

TABLE 3
Dry Matter, Protein, Lipid, Energy and Phosphorus
as a Function of Drying Temperature

| | Dry | | | | |
|---|---|---|---|---|---|
| Diets | matter | Protein | Lipid | Energy | Phosphorus |
| WAS dried at 68° C. | 76.9 | 89.1 | 99.1 | 80.7 | 48.9 |
| WAS dried at 80° C. | 50.0 | 65.5 | 70.5 | 28.6 | 18.4 |
| WAS dried at 95° C. | 25.0 | 46.9 | * | * | 8.6 |
| WAS dried at 110° C. | 50.0 | 64.7 | 74.4 | 26.6 | * |
| WAS dried at 125° C. | 57.7 | 66.4 | 79.8 | 38.0 | 32.8 |

* indicates that the data were unable to be collected

Conclusion: there is a general trend of decreasing digestibility and availability of protein, lipid, and energy with increased drying temperature.

### Example 76

### Effects of Microwave Treatment on the Digestibility and Viable Microbes of Waste Activated Sludge

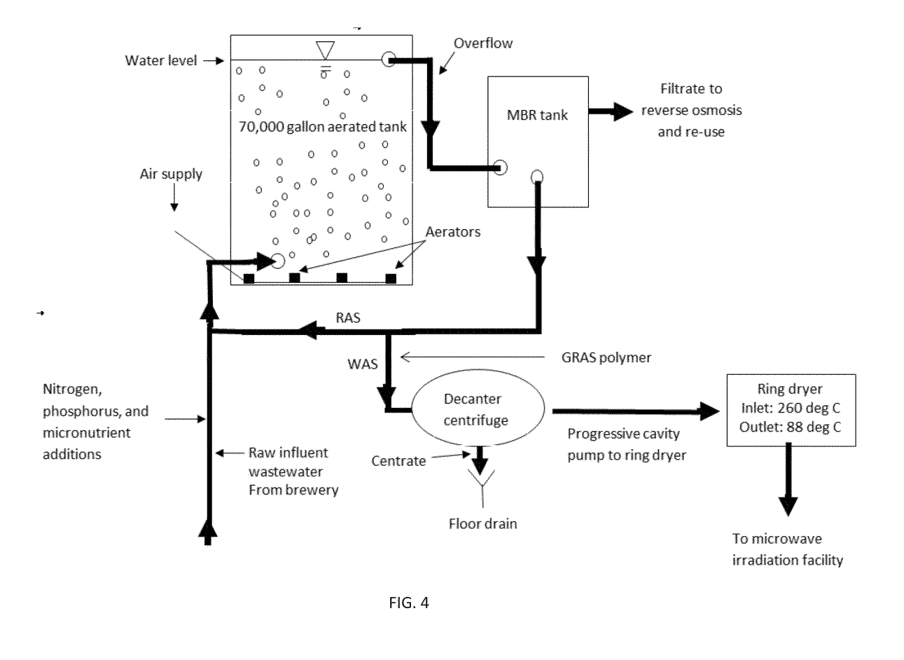

An aqueous waste stream from a brewery containing BOD, and nutrients was continuously supplied to an aerated tank to produce a cellular biomass. This biomass was then separated from the bulk water using a membrane filter, a portion of it was returned to the aerobic basin, and a portion of it was removed from the system as waste activated sludge comprised of approximately 1% solids. A food grade polymer was added to this waste activated sludge as it was piped to a decanter centrifuge and dewatered to contain approximately 16% solids and 84% water. The resulting dewatered waste activated was then dried in a ring dryer with an inlet temperature of 260° C. and an outlet temperature of 88° C. This outlet temperature corresponds to a final moisture content of less than 10%. This dried material was then transported to a facility that possessed a demonstration microwave dryer that allowed variable power levels and exposure times to be tested. This process is further illustrated in FIG. 4 as well as in method 101 in FIG. 1.

Microwave testing: Samples were prepared by microwaving at various times and power levels as shown below in Table 4. The sample with 20% moisture was prepared by adding the appropriate quantity of water to the dried (9.7% moisture) waste activated sludge. The digestibility of the samples was then measured using Novus International's IDEA assay (see: Table 5).

TABLE 4
Sample Moisture Content and Microwave Parameters Used

| | Moisture | Microwave | Microwave | Moisture |
|---|---|---|---|---|
| Sample | Initial (%) | Power (kW) | duration (min) | Final (%) |
| Control | 9.7 | 0 | 0 | 9.7 |
| 1 | 9.7 | 10 | 3 | 7.6 |
| 2 | 16.8 | 10 | 2.5 | 9.5 |
| 3 | 20.0 | 10 | 3.25 | 9.6 |

TABLE 5
Protein Digestibility Assays as a
Function of Microwave Parameters

% digestibility of
individual amino acids

| | Control | 1 | 2 | 3 |
|---|---|---|---|---|
| IDEA Alanine | 64 | 61 | 61 | 59 |
| IDEA Arginine | 77 | 75 | 76 | 74 |
| IDEA Aspartic Acid | 71 | 69 | 69 | 67 |
| IDEA Cystine | 61 | 57 | 57 | 55 |
| IDEA Glutamic Acid | 78 | 76 | 76 | 75 |
| IDEA Histidine | 75 | 72 | 73 | 71 |
| IDEA Isoleucine | 66 | 62 | 63 | 60 |
| IDEA Leucine | 68 | 65 | 65 | 63 |
| IDEA Lysine | 71 | 69 | 69 | 68 |
| IDEA Methionine | 65 | 62 | 62 | 60 |
| IDEA Phenylalanine | 71 | 68 | 68 | 66 |
| IDEA Proline | 74 | 72 | 72 | 70 |
| IDEA Serine | 69 | 66 | 67 | 65 |
| IDEA Threonine | 68 | 65 | 65 | 63 |
| IDEA Tryptophan | 67 | 63 | 64 | 61 |
| IDEA Tyrosine | 71 | 68 | 68 | 66 |
| IDEA Valine | 63 | 60 | 60 | 57 |

These results show that microwaving has a minimal impact on digestibility. These same samples were then analyzed for viable microbial content. Results are shown in Table 6.

TABLE 6
Microbial Content of Microwaved Samples

| | Control | | Sample 1a | | Sample 2b | | Sample 4a | |
|---|---|---|---|---|---|---|---|---|
| | Ring-dried sample, | | Ring-dried sample, | | Ring-dried sample, | | Ring-dried sample, | |
| | 9.7% initial | | 9.7% initial | | 16.8% initial | | 20.0% initial | |
| | moisture, no | | moisture, 10 kw - | | moisture, 10 kw - | | moisture, 10 kw - | |
| | microwave | | 3 min, 7.6% | | 2.5 min, 9.5% | | 3.25 min, 9.6% | |
| Test | treatment | | final moisture | | final moisture | | final moisture | |
| Aerobic Plate Count | 4.3 × 10⁵ | CFU/g | 1.3 × 10⁵ | CFU/g | 1.1 × 10⁵ | CFU/g | 2.9 × 10⁴ | CFU/g |
| Bacillus cereus | 2.0 × 10⁴ | CFU/g | 7.5 × 10³ | CFU/g | 295 | CFU/g | 175 | CFU/g |
| Campylobacter jejuni | 45 | CFU/g | Less Than 10 CFU/g | | Less Than 10 CFU/g | | Less Than 10 CFU/g | |
| Clostridium perfringens | 315 | CFU/g | 55 | CFU/g | Less Than 10 CFU/g | | 25 | CFU/g |
| Sulfite-Reducing Clostridia | 3.0 × 10³ | CFU/g | 55 | CFU/g | 70 | CFU/g | 50 | CFU/g |

| Enterobacteriaceae | 1.1 × 10³ | MPN/g | Less Than 3 MPN/g | | Less Than 3 MPN/g | Less Than 3 MPN/g | |
|---|---|---|---|---|---|---|---|
| Coliform | 645 | CFU/g | Less Than 10 CFU/g | | Less Than 10 CFU/g | Less Than 10 CFU/g | |
| E. coli | 70 | CFU/g | Less Than 10 CFU/g | | Less than 10 CFU/g | Less Than 10 CFU/g | |
| Salmonella | Negative per 25 grams | | Negative per 25 grams | | Negative per 25 grams | Negative per 25 grams | |
| S. aureus | Less Than 10 CFU/g | | Less Than 10 CFU/g | | Less Than 10 CFU/g | Less Than 10 CFU/g | |
| Yeast/Mold | 5.8 × 10⁴ | CFU/g | 1.3 × 10⁴ | CFU/g | Less Than 10 CFU/g | 10 | CFU/g |

These results show that the microbial count declines with increased exposure to microwave power and duration even while digestibility stay relatively constant.

### Example 77

### E-Beam Sterilization of Waste Activated Sludge

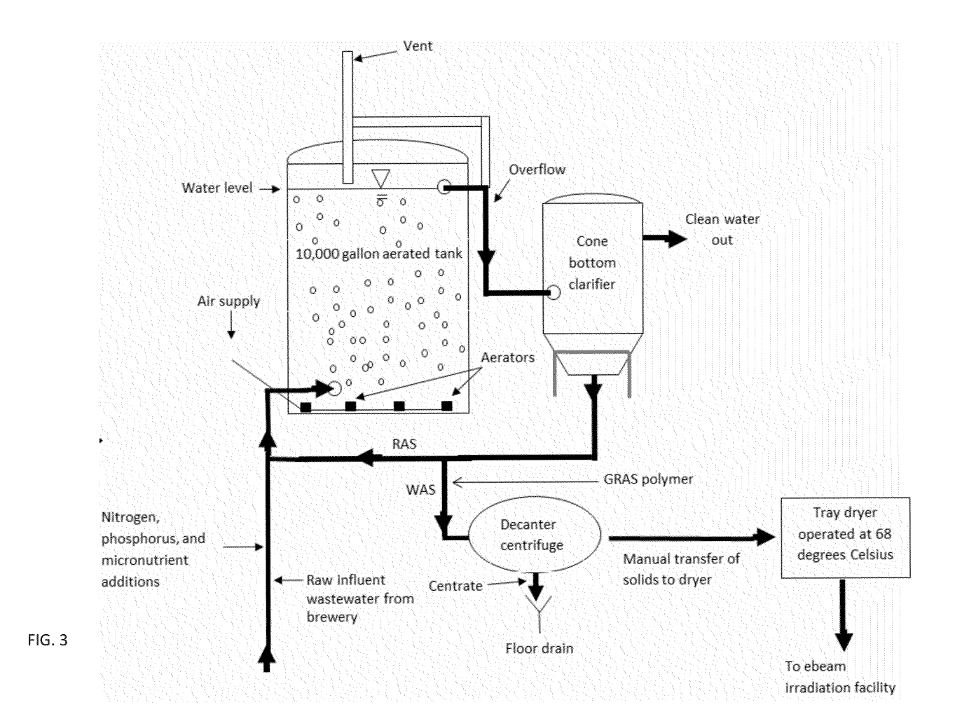

An aqueous waste stream from a brewery containing BOD, and nutrients was continuously supplied to an aerated tank to produce a cellular biomass. This biomass was then separated from the bulk water in a gravity clarifier, a portion of it was returned to the aerobic basin, and a portion of it was removed from the system as waste activated sludge comprised of approximately 2% solids. A food grade polymer was added to this waste activated sludge as it was piped to a decanter centrifuge. It was subsequently dewatered in the centrifuge to contain about 16% solids and 84% water. This waste activated sludge was then dried at 68° C. until the moisture content was less than 10%. Various doses of e-beam radiation were then delivered to subsamples of this material and bacillus spore viability was measured to determine effectiveness of the radiation treatments. The foregoing process is further illustrated in FIG. 3 and in method 101 in FIG. 1.

TABLE 7
E-beam Treated Samples

| | | bacillus |
|---|---|---|
| Sample No | Dose | spores/gram |
| 1 | No Dose, CONTROL | 2100 |
| 2 | 2.0 kGy | 510 |
| 3 | 3.1 kGy | 160 |
| 4 | 4.0 kGy | 100 |
| 5 | 5.0 kGy | 20 |
| 6 | 6.1 kGy | 25 |
| 7 | 7.0 kGy | 25 |
| 8 | 8.1 kGy | 20, 20 |
| 9 | 9.9 kGy | <10, 20 |
| 10 | 12.0 kGy | 25, 25 |
| 11 | 14.0 kGy | 10 |

These results show that ebeam radiation is effective in inactivating spores within dried waste activated sludge and that a dose of 3.1 kilograys results in greater than one order of magnitude inactivation of bacillus spores and that a dose of 4.0 kilograys will reduce a starting concentration of 2,100 spores/gram to approximately 100 spores/gram. It is common within the animal feed industry that the maximum allowable concentration of bacillus spores in an ingredient is 100 spores/gram.

The digestibility of individual amino acids was also measured on this same sample and was analyzed as a function of ebeam dose. The results are shown in Table 8 below.

TABLE 8
Digestibility of E-beam Treated Samples

| Sample | | No Dose | 4.0 kGy dose | 5.0 kGy dose |
|---|---|---|---|---|
| No. | AA | g/100 g | g/100 g | g/100 g |
| | Non-essential AA | | | |
| 1 | Ala | 3.75 | 3.21 | 3.67 |
| 2 | Asp + ASN | 5.23 | 4.76 | 4.90 |
| 4 | Cys | 0.29 | 0.30 | 0.31 |
| 6 | Glu + Gln | 5.27 | 6.13 | 5.57 |
| 7 | Gly | 2.28 | 2.68 | 2.38 |
| 8 | Pro | 3.11 | 2.79 | 2.52 |
| 9 | Ser | 1.80 | 2.06 | 2.37 |
| 10 | Tyr | 3.32 | 3.03 | 3.04 |
| | Taurine | 0.00 | 0.00 | 0.00 |
| | Essential AA | | | |
| 1 | Arg | 2.95 | 3.11 | 2.98 |
| 2 | His | 1.30 | 1.45 | 1.07 |
| 3 | Ile | 3.49 | 3.51 | 3.33 |
| 4 | Leu | 3.98 | 3.46 | 3.86 |
| 5 | Lys | 3.32 | 3.35 | 3.44 |
| 6 | Met | 1.02 | 1.51 | 1.01 |
| 7 | Phe | 3.14 | 3.03 | 3.41 |
| 8 | Thr | 3.19 | 2.72 | 3.58 |
| 9 | Trp | 0.23 | 0.30 | 0.21 |
| 10 | Val | 3.42 | 3.64 | 3.93 |
| Total | | 51.08 | 51.03 | 51.56 |

These results show that an increase in ebeam dose generally does not decrease amino acid digestibility and, when it does, this decrease is slight.

### Example 78

### Digestibility of Waste Activated Sludge as a Function of Ring Drying Conditions

An aqueous waste stream from a brewery containing BOD, and nutrients was continuously supplied to an aerated tank to produce a cellular biomass. This biomass was then separated from the bulk water using a membrane filter, a portion of it was returned to the aerobic basin, and a portion of it was removed from the system as waste activated sludge comprised of approximately 1% solids. A food grade polymer was added to this waste activated sludge as it was piped to a decanter centrifuge and dewatered to contain approximately 16% solids and 84% water. The resulting dewatered waste activated sludge was then dried in a ring dryer with variable inlet temperatures and an outlet temperature of approximately 88° C. This outlet temperature corresponds to a final moisture content of less than 10%. The digestibility of the individual amino acids in the dried samples was then measured using Novus International's IDEA assay. Results are shown in Table 9.

TABLE 9
Protein Digestibility as a Function of Ring dryer Inlet Temperature

| | Inlet temperature | | | |
|---|---|---|---|---|
| | versus % digestibility | | | |
| | 204 C. | 230 C. | 245 C. | 275 C. |
| IDEA Alanine | 86.7 | 87.1 | 87.5 | 84.0 |
| IDEA Arginine | 92.5 | 92.8 | 93.1 | 90.7 |
| IDEA Aspartic Acid | 89.3 | 89.6 | 89.9 | 87.1 |
| IDEA Cystine | 91.3 | 91.8 | 92.4 | 87.7 |
| IDEA Glutamic Acid | 92.3 | 92.6 | 92.8 | 90.6 |
| IDEA Histidine | 91.5 | 91.8 | 92.2 | 89.5 |
| IDEA Isoleucine | 91.1 | 91.6 | 92 | 88.1 |
| IDEA Leucine | 91.0 | 91.4 | 91.8 | 88.3 |
| IDEA Lysine | 89.3 | 89.6 | 90 | 87.2 |
| IDEA Methionine | 90.9 | 91.3 | 91.8 | 87.8 |
| IDEA Phenylalanine | 92.2 | 92.6 | 92.9 | 89.6 |
| IDEA Proline | 93.5 | 93.9 | 94.2 | 91.2 |
| IDEA Serine | 92.3 | 92.7 | 93.1 | 89.6 |
| IDEA Threonine | 89.3 | 89.7 | 90.1 | 86.8 |
| IDEA Tryptophan | 96.7 | 97.2 | 97.8 | 93.2 |
| IDEA Tyrosine | 94.6 | 95.0 | 95.5 | 91.8 |
| IDEA Valine | 89.1 | 89.6 | 90.1 | 86.0 |
| AVG | 91.4 | 91.8 | 92.2 | 88.8 |

These results show that inlet temperature of the ring dryer does not affect digestibility of amino acids until 245° C. is exceeded.

### Example 79

### Digestibility of Waste Activated Sludge as a Result of Dewatering followed by Heat Treatment

An aqueous waste stream from a brewery containing BOD, and nutrients was continuously supplied to an aerated tank to produce a cellular biomass. Toilets, urinals, sinks, kitchens, and showers within this brewery also emptied into the brewery wastewater and it is therefore regulated as a domestic sewage facility. This biomass was then separated from the bulk water using a gravity settler, a portion of it was returned to the aerobic basin, and a portion of it was removed from the system as waste activated sludge comprised of approximately 2% solids. A food grade polymer was added to this waste activated sludge and it was thickened in a low-centrifugal-force centrifuge to contain approximately 6% solids and 94% water. The resulting thickened activated sludge was then (1) dried in a freeze dryer, or (2) at 105° C. or 87° C. in a thermal convection dryer, and then microwaved until the internal temperature reached 100° C.-104° C. (211° F.-220° F.). This process is further illustrated in method 102 in FIG. 1 The digestibility of the individual amino acids in the samples was then measured using Novus International's IDEA assay and the microbial content was determined at an ISO 17025 microbial testing laboratory. Results are shown below in Table 10 and Table 11.

TABLE 10
Protein Digestibility as a Function of Heat Treatment

| | | Thickened, dried | Thickened, dried | |
|---|---|---|---|---|
| | Thickened, freeze- | at 105° C., | at 87° C., | |
| | dried, microwaved | microwaved | microwaved | Control centrifuged |
| | (110 kW · s^{a}) | (120 kW · s) | (125 kW · s) | and freeze dried |
| | IDEA digestibility | IDEA digestibility | IDEA digestibility | IDEA digestibility |
| Amino acid | value^{b} | value^{a} | value^{a} | value^{a} |
| IDEA Alanine | 96 | 58 | 72 | 98 |
| IDEA Arginine | 98 | 73 | 82 | 100 |
| IDEA Aspartic Acid | 96 | 66 | 77 | 98 |
| IDEA Cystine | 103 | 52 | 71 | 106 |
| IDEA Glutamic Acid | 98 | 73 | 83 | 99 |
| IDEA Histidine | 98 | 70 | 80 | 100 |
| IDEA Isoleucine | 101 | 58 | 74 | 104 |
| IDEA Leucine | 100 | 62 | 76 | 102 |
| IDEA Lysine | 96 | 66 | 77 | 98 |
| IDEA Methionine | 101 | 58 | 74 | 103 |
| IDEA Phenylalanine | 101 | 65 | 78 | 103 |
| IDEA Proline | 101 | 69 | 81 | 103 |
| IDEA Serine | 101 | 63 | 77 | 103 |
| IDEA Threonine | 98 | 62 | 75 | 100 |
| IDEA Tryptophan | 108 | 59 | 77 | 111 |
| IDEA Tyrosine | 104 | 64 | 79 | 106 |
| IDEA Valine | 99 | 56 | 72 | 102 |
| Total protein | 96.7% | 31.8% | 55.7% | 100% |
| digestibility^{a} | | | | |

^{a}kilowatt seconds
^{b}higher value corresponds to greater digestibility

TABLE 11
Microbial Counts of Heat Treated Waste Activated Sludge

| | | Thickened, dried | Thickened, dried | Control |
|---|---|---|---|---|
| | Thickened, freeze- | at 105° C., | at 87° C., | centrifuged |
| | dried, microwaved | microwaved | microwaved | and freeze dried |
| | (110 kW · s; CFU/g^{a} | (120 kW · s; CFU/g | (125 kW · s; CFU/g | (CFU/g unless |
| | unless specified | unless specified | unless specified | specified |
| Microbe type | otherwise) | otherwise) | otherwise) | otherwise) |
| Bacillus cereus | 2,000 | BDL^{b} | 40 | 11,000 |
| Campylobacter jejuni | 30 | BDL | BDL | 64 |
| Clostridium perfringens | 8,000 | 150 | 550 | 118,000 |
| Sulfite-reducing Clostridia | 16,000 | 250 | 1,400 | 23,000 |
| Enterobacteriaceae | 240 MPN/g^{c} | 3.6 MPN/g | 15 MPN/g | 460 MPN/g |
| Coliform | BDL | BDL | BDL | BDL |
| E. coli | BDL | BDL | BDL | BDL |
| Salmonella | Negative per 25 g | Negative per 25 g | Negative per 25 g | Negative per 25 g |
| S. aureus | 580,000 | BDL | BDL | 360,000 |
| Yeast and mold | 160,000 | 24,000 | 55,000 | 3,100,000 |

^{a}colony forming units per gram;
^{b}below detection limit;
^{c}most probable number per gram; one kW*s is 1000 W applied for one second

These results show that the digestibility of the protein is the highest when it is exposed to freeze drying only; however, the digestibility decreases only minimally when it is freeze dried and then microwaved to achieve an internal temperature of 100° C.-104° C. This is in contrast to both of the samples that were dried in a conventional thermal dryer and then microwaved to achieve an internal temperature of 100° C.-104° C. The samples dried at 105° C. and 87° C. had a total protein digestibility of 31.8% and 55.7%, respectively versus the sample that was freeze dried and then microwaved which had a total protein digestibility of 96.7%. This shows that freeze drying is vastly superior to conventional dryers when maximizing protein digestibility is desired. This result was unexpected, as U.S. Pat. No. 7,931,806 discloses the use of conventional thermal dryers between the temperatures of 55° C. and 105° C. for the drying of waste activated sludge for the purpose of preserving protein digestibility. It is possible that temperatures lower than 87° C. and as low as 55° C. would dry the material in a manner to preserve protein, however the size and cost of a thermal dryer designed to operate at such low temperature is cost prohibitive.

Additionally, the slow pace of the drying process at low temperatures allows for the production of products such as biogenic amines and the replication of heat tolerant microorganisms (especially the spore formers). As a result, it is highly probable that the dried activated sludge would be unsuitable for use as a feed, food, or fertilizer. The microbial data show that thermal desiccation of the material is generally superior to freeze drying followed by microwaving. However, the sludge tested in this example contains significant quantities of human waste. It is therefore preferred to select wastewater treatment plants dedicated solely to a food production process in order to avoid the presence of harmful microbes in the sludge. Versus the freeze-dried control, the freeze-dried and microwaved sample generally demonstrated significantly lower microbial counts and showed that microwaving is an effective means for inactivating microbes in the resulting dried sludge. The combination of wastewater treatment plant selection, thermal ring drying as shown in example 78 is expected to deliver a dried activated sludge with low microbial counts and high digestibility.

### Example 80

### Digestibility of Waste Activated Sludge as a Result of Dewatering followed by Heat Treatment

An aqueous waste stream from a brewery containing BOD, and nutrients was continuously supplied to an aerated tank to produce a cellular biomass. Toilets, urinals, sinks, kitchens, and showers within this brewery also emptied into the brewery wastewater and it is therefore regulated as a domestic sewage facility. This biomass was then separated from the bulk water using a gravity settler, a portion of it was returned to the aerobic basin, and a portion of it was removed from the system as waste activated sludge comprised of approximately 2% solids. A food grade polymer was added to this waste activated sludge and it was thickened in a low-centrifugal-force centrifuge to contain approximately 6% solids and 94% water. The resulting thickened activated sludge was then split into two samples. One of these samples was autoclaved at 121° C. for 15 minutes and while the other was not autoclaved. The digestibility of the individual amino acids in the samples was then measured using Novus International's IDEA assay and the microbial content was determined at an ISO 17025 microbial testing laboratory. Results are shown below in Table 12 and Table 13.

TABLE 12
Protein Digestibility of Heat Treated Waste Activated Sludge

| | Thickened waste activated | Thickened waste |
|---|---|---|
| | sludge autoclaved at | activated sludge, |
| | 121° C. for 15 minutes, | IDEA digestibility |
| Amino acid | IDEA digestibility value^{a} | value^{a} |
| IDEA Alanine | 72 | 64 |
| IDEA Arginine | 77 | 75 |
| IDEA Aspartic Acid | 40 | BDL |
| IDEA Cystine | BDL^{b} | BDL |
| IDEA Glutamic Acid | 65 | 56 |
| IDEA Glycine | 73 | 66 |
| IDEA Histidine | 54 | 50 |
| IDEA Isoleucine | 59 | 47 |
| IDEA Leucine | 62 | 50 |
| IDEA Lysine | BDL | BDL |
| IDEA Methionine | 56 | 44 |
| IDEA Phenylalanine | 73 | 66 |
| IDEA Proline | 68 | 63 |
| IDEA Serine | 62 | 56 |
| IDEA Threonine | 59 | 47 |
| IDEA Tryptophan | 79 | 69 |
| IDEA Tyrosone | 77 | 71 |
| IDEA Valine | 62 | 54 |

^{a}higher value corresponds to greater digestibility;
^{b}below detection limit

TABLE 13
Bacterial Counts of Heat Treated Waste Activated Sludge

| | Thickened waste activated | |
|---|---|---|
| | sludge autoclaved at 121° C. | Thickened waste activated |
| | for 15 minutes (CFU/g^{a} unless | sludge (CFU/g unless |
| Microbe type | specified otherwise) | specified otherwise) |
| Bacillus cereus | 7,500 | 22,000 |
| Campylobacter jejuni | BDL^{b} | BDL |
| Clostridium perfringens | 240 | 30,000 |
| Sulfite-reducing Clostridia | 320 | 52,000 |
| Enterobacteriaceae | BDL | 23 MPN/g^{c} |
| Coliform | BDL | BDL |
| E. coli | BDL | BDL |
| Salmonella | Negative per 25 g | Negative per 25 g |
| S. aureus | BDL | 22,000 |
| Yeast and mold | BDL | 11,000 |

^{a}colony forming units per gram;
^{b}below detection limit;
^{c}most probable number per gram

These results show that autoclaving unexpectedly increases the digestibility of the resulting activated sludge. Additionally, the microbial counts of the autoclaved sample are significantly lower than for the sample that was not autoclaved. Because these samples were taken from a brewery wastewater treatment plant that is designated as a domestic sewage facility, the absolute values are not important. The trends however, show that the autoclaving of waste activated sludge has surprising beneficial effects in terms of digestibility and results in effective microbial inactivation.

### Example 81

### Mineral Composition of Ring-Dried Waste Activated Sludge Used as a Fertilizer

An aqueous waste stream from a brewery containing BOD, and nutrients was continuously supplied to an aerated tank to produce a cellular biomass. This biomass was then separated from the bulk water using a membrane filter, a portion of it was returned to the aerobic basin, and a portion of it was removed from the system as waste activated sludge comprised of approximately 1% solids. A food grade polymer was added to this waste activated sludge as it was piped to a decanter centrifuge and dewatered to contain approximately 16% solids and 84% water. The resulting dewatered waste activated sludge was then dried in a ring dryer with an inlet temperature of 245° C. and an outlet temperature of approximately 88° C. This outlet temperature corresponds to a final moisture content of less than 10%. The dried material had a crude protein content of 45% as analyzed on a Leco protein analyzer. Five composite samples of this material were created and analyzed for N, P₂O₅, K₂O, Ca, Mg, B, Cu, Fe, Mn, Mo, and Zn as well as a heavy metals using acid digestion and ICP for all mineral nutrients except N. The N was determined by combustion in a CNS 2000 analyzer. Five replications (samples) were conducted. The mean (average) concentration of each mineral nutrient in the fertilizer and the standard deviations of the means were determined and provided.

### Results:

The fertilizer contained nearly 7% N. This was lower than a typical fish meal (typically 10% N), higher than fish emulsion or hydrolysate (2%-5%) and similar to cotton seed meal (7%).
The fertilizer contained over 3% P₂O₅. This was lower than for fish meal (6%) but similar to that of fish emulsion and hydrolysate (2%-3%). It was also similar to the P₂O₅ concentration of cotton seed meal.
The fertilizer contained 0.5% K₂O which was lower than that of typical cotton seed meal (2%), fish emulsion (2%) and fish meal (2%). It was similar to that of typical fish hydrolysate (0-1%).
The fertilizer contained low levels of other mineral elements.
As shown in Table 14 and Table 15

TABLE 14
Total mineral element analysis of ring-dried
waste activated sludge fertilizer^{z}.

| | | Standard | Minimum | Maximum |
|---|---|---|---|---|
| Mineral element | Mean^{y} | deviation^{y} | value | value |
| Nitrogen (N) | 6.84 | 0.18 | 6.66 | 7.08 |
| Phosphate (P₂O₅) | 3.13 | 0.13 | 2.95 | 3.26 |
| Potash (K₂O) | 0.55 | 0.07 | 0.43 | 0.60 |
| Calcium (Ca) | 1.03 | 0.18 | 0.83 | 1.24 |
| Magnesium (Mg) | 0.44 | 0.02 | 0.42 | 0.47 |
| Boron (B) | 0.006 | 0.001 | 0.006 | 0.008 |
| Copper (Cu) | 0.017 | 0.006 | 0.013 | 0.028 |
| Iron (Fe) | 0.08 | 0.004 | 0.07 | 0.09 |
| Manganese (Mn) | 0.004 | 0.0006 | 0.004 | 0.005 |
| Molybdenum (Mo) | 0.0003 | 0.0001 | 0.0002 | 0.0004 |
| Zinc (Zn) | 0.009 | 0.0007 | 0.008 | 0.010 |

^{z}Values expressed as a percentage (%) of dry weight of the material.
^{y}Means and standard deviations from five random samples as provided.

TABLE 15
Heavy metals analysis of ring-dried
waste activated sludge fertilizer^{z}.

| | | Standard | Minimum | Maximum |
|---|---|---|---|---|
| Mineral element | Mean^{y} | deviation^{y} | value | value |
| Arsenic (As) | 0 | 0 | 0 | 0 |
| Silver (Ag) | 1.18 | 0.83 | 0.55 | 2.59 |
| Barium (Ba) | 12.39 | 0.27 | 11.9 | 12.6 |
| Cadmium (Cd) | 0 | 0 | 0 | 0 |
| Cobalt (Co) | 2.41 | 0.85 | 1.43 | 3.11 |
| Chromium (Cr) | 17.0 | 1.18 | 15.7 | 18.3 |
| Copper (Cu) | 94.9 | 9.11 | 83.4 | 103.1 |
| Molybdenum (Mo) | 1.65 | 0.17 | 1.42 | 1.84 |
| Nickel (Ni) | 22.0 | 5.04 | 15.1 | 28.11 |
| Lead (Pb) | 0 | 0 | 0 | 0 |
| Selenium (Se) | 0.50 | 0.66 | 0 | 1.66 |
| Zinc (Zn) | 64.6 | 4.95 | 58.3 | 69.2 |
| Mercury (Hg) | 0 | 0 | 0 | 0 |

^{z}Values expressed as mg/Kg of dry fertilizer.
^{y}Means and standard deviations from five random samples as provided.

These results show that ring-dried waste activated with a crude protein content of 45% has mineral characteristics similar to premium fertilizers.

### Example 82

### Determination of Release and Availability of Mineral Nutrients of Ring-Dried Waste Activated Sludge Over Time in a Greenhouse Environment

An aqueous waste stream from a brewery containing BOD, and nutrients was continuously supplied to an aerated tank to produce a cellular biomass. This biomass was then separated from the bulk water using a membrane filter, a portion of it was returned to the aerobic basin, and a portion of it was removed from the system as waste activated sludge comprised of approximately 1% solids. A food grade polymer was added to this waste activated sludge as it was piped to a decanter centrifuge and dewatered to contain approximately 16% solids and 84% water. The resulting dewatered waste activated sludge was then dried in a ring dryer with an inlet temperature of 245° C. and an outlet temperature of approximately 88° C. This outlet temperature corresponds to a final moisture content of less than 10%. The dried material had a crude protein content of 45% as analyzed using a Leco protein analyzer. This material was then used to determine the release and availability of mineral nutrients of waste activated fertilizer over time in a greenhouse environment. Because many variables affect release and availability of mineral nutrients from organic compounds (e.g. microbial activity, microbial populations, substrates, temperature, etc.), the release and availability was conducted in a greenhouse under specified conditions and compared to an untreated (no fertilizer) control.

A standard greenhouse root substrate (substrate) containing 80% Canadian sphagnum peat and 20% perlite (v/v) was formulated. The substrate was amended with calcitic limestone to adjust the starting pH of the substrate to 5.8. The substrate was amended with the fertilizer at a rate of 0, 1 gram or 4 grams the fertilizer per 6-inch container. The 0 (zero) rate served as a control and also accounted for any mineral nutrients provided by the substrate. The 1 gram rate was established to represent a low application rate, and the 4 gram rate was established to represent a medium or average application rate. Therefore, there were 3 fertilizer rate treatments.

The substrates amended with the different fertilizer rates were placed into 6-inch plastic containers. The containers were placed in a glass-glazed greenhouse on the University of Arkansas campus (Fayetteville, Ariz.). The air temperatures ranged from 65° F. (18° C.) and 95° F. (35 C). Light levels averaged 450 μmol·m⁻² s⁻¹ at 12:00 HR. The substrates in the containers were kept moist (to allow microbial activity) by applying deionized water as required to maintain moist substrates. At each irrigation, enough water was applied to fully moisten the substrate but to not allow leaching of mineral nutrients from the containers (typically 100 mL per day).

After 0, 1, 2, 3, 4, 5, 6, 7, 8, 12 and 16 weeks (11 sample times), three (3) containers were sampled for each of the fertilizer treatments and a saturated media extract (deionized water extraction) analysis was performed to determine water-soluble (readily available) NH₄⁺, NO₃⁻, P, K, Ca, Mg, B, Cu, Fe, Mn, Mo, and Zn. The pH and electrical conductivity of each sample were also determined.

For each mineral nutrient, the mean values and the standard deviation of the means were plotted at each sample time. Additionally, the concentration of each mineral nutrient was regressed against time. This displayed and modeled the release and availability of each mineral nutrient provided by the fertilizer over time under the described environmental conditions. It visually demonstrated if the mineral nutrients contained in the fertilizer rapidly became available or if the there was a delay or lag time.

This also allowed a comparison of what is provided by the substrate versus the fertilizer as well as differences between the low and medium fertilizer rates.

### Results:

Within 7 days, the fertilizer, when incorporated at 4 grams, released significant amounts of NO₃⁻, and the NO₃⁻ concentration remained higher than the NO₃⁻ concentration in the control for 4 weeks.
Within 7 days, the fertilizer, when incorporated at 4 grams, released significant amounts of NH₄⁺, and the NH₄⁺ concentration remained higher than the NH₄⁺ concentration in the control for approximately 2 weeks.
Within 7 days, the fertilizer, when incorporated at 4 grams, released significant amounts of P, and the P concentration remained higher than the P concentration in the control for 6 weeks.
Within 7 days, the fertilizer, when incorporated at 4 grams, released significant amounts of K, and the K concentration remained higher than the K concentration in the control for 7 weeks.
Within 14 days, the fertilizer, when incorporated at 4 grams, released significant amounts of Ca and Mg, and the Ca and Mg concentrations remained higher than the Ca and Mg concentrations in the control for 4 weeks.
The Fe, Mn, B, Cu, Zn, Mo, Na, and Al concentration did not differ significantly among the different fertilizer treatments.
The application of 4 grams of the fertilizer per pot resulted in approximately a 0.5 unit decrease in pH beginning at sampling week 2. This was most likely a result of substrate acidification due to the conversion of NH₄⁺ to NO₃⁻ (as well as other microbial activities).
The application of 4 grams of the fertilizer per pot resulted in an increase in electrical conductivity (EC) beginning at sampling week 2 and continuing until week 5. This was most likely a result of increase concentrations of mineral element ions (i.e. NO₃⁻, NH₄⁺, etc.) supplied by the fertilizer.

These results show that ring-dried waste activated with a crude protein content of 45% has leaching characteristics similar to premium fertilizers.

1. A method of producing a solid protein feed product from waste water, comprising:
(a) growing microbial cells in an aqueous waste stream to produce waste activated sludge;
(b) drying the dewatered waste activated sludge to a solids content of about 80-90 wt. % solids; and
(c) sterilizing the waste activated sludge before, during, or after said dewatering or said drying to provide a solid protein feed product which is commercially sterile;
wherein protein quality of the solid protein feed product is substantially unchanged from that of the waste activated sludge prior to sterilizing and drying.

2. The method of claim 1, further comprising dewatering the waste activated sludge to a solids content of about 9-28 weight percent solids prior to step (b).

3. The method of claim 1 of-2, wherein the total protein content of the solids content of the solid protein feed product is at least about 40 wt. %.

4-5. (canceled)

6. The method of claim 1, wherein said sterilizing of step (c) is by e-beam, gamma irradiation, microwave radiation, enzymatic treatment, heating, ultrasound, pressure drop, or any combination thereof.

7. The method of claim 1, wherein after said sterilizing at step (c), no single viable microbial species is present in amounts in excess of about 50 cfu/g.

8. (canceled)

9. The method of claim 1, wherein said sterilizing of step (c) is by heating at a temperature of from about 120° C. to about 160° C.

10. (canceled)

11. The method of claim 1, wherein said sterilizing of step (c) is by one or more of e-beam irradiation, gamma radiation, or microwave radiation.

12-13. (canceled)

14. The method of claim 11, wherein wherein said sterilizing of step (c) is by microwave radiation and the wavelength of the microwave radiation ranges from about 915 MHz to about 2450 MHz, and wherein the microwave power of the microwave radiation ranges from about 8 kW to about 80 kW.

15. The method of claim 14, wherein said sterilizing of step (c) occurs after said drying of step (b).

16. The method of claim 1, wherein said sterilizing of step (c) comprises enzymatic treatment with proteases and/or other enzymes, whereby the functional parts of the cell membrane or cell wall are broken down.

17. The method of claim 1, wherein said sterilizing of step (c) comprises exposing the waste activated sludge to a rapid pressure drop.

18. The method of claim 1, wherein said sterilizing of step (c) comprises exposing the waste activated sludge to ultrasonic cavitation.

19. The method of claim 1, wherein said drying of step (b) is performed at a temperature from about 80° C. to about 315° C.

20. (canceled)

21. The method of claim 1, wherein said drying of step (b) is carried out in a single pass oven, a dual pass oven, a rotary drum dryer, a ring dryer, a flash dryer, a spray dryer, a spin flash dryer, or a super-heated steam dryer.

22. (canceled)

23. The method of claim 1, further comprising (d) adding a coagulant to the waste activated sludge, said coagulant selected from the group consisting of an anionic polymer, a non-ionic polymer, a cationic polymer, polyacrylamide based polymers, human food-grade polymers, animal feed grade polymers, and combinations thereof.

24. The method of claim 23, wherein the coagulant is added prior to said sterilizing.

25. The method of claim 23, wherein the coagulant is added after said sterilizing.

26. (canceled)

27. The method of claim 1, further comprising adding a preservative to the waste activated sludge.

28. (canceled)

29. The method of claim 2, wherein the water content of the solid protein feed product is 10% or less, and digestible protein content of the solids content is at least about 40 wt. %.

30. The method of claim 29, wherein the digestible protein content of the solids content is at least about 50 wt. %.

31-33. (canceled)

34. The method of claim 29, wherein the digestible protein content of the solids content is at least about 90 wt. %.

35. The method of claim 1, wherein the protein feed product is classifiable as a feed as defined in the “CODE OF PRACTICE ON GOOD ANIMAL FEEDING” of the Food and Agriculture Organization of the United Nations. (Document CAC/RCP 54-2004)

36. A solid protein feed product prepared by the process of claim 1.

37. The solid protein feed product of claim 36, wherein the water content is 10% or less and the digestible protein content of the solids content is at least about 40 wt. %.

38. The solid protein feed product of claim 37, wherein the digestible protein content of the solids content is at least 50 wt. %.

39-42. (canceled)

43. The solid protein feed product of claim 37, classifiable as a feed as defined in the “CODE OF PRACTICE ON GOOD ANIMAL FEEDING” of the Food and Agriculture Organization of the United Nations. (Document CAC/RCP 54-2004)

44. An agricultural fertilizer comprising the solid protein feed product of claim 36.

45. The method of claim 1, wherein dewatering of the waste activated sludge to a solids content of about 9-28 wt. % occurs during said drying of step (b), and said dewatering and drying are followed by said sterilizing of step (c).
